(19) United States
(12) Patent Application Publication
(10) Pub. No.: US 2025/0274203 A1
(43) Pub. Date: Aug. 28, 2025

(54) LOCATION-AWARE WIRELESS NETWORK ROAMING FOR ROBOTICS SYSTEMS AND APPLICATIONS

(71) Applicant: NVIDIA Corporation, Santa Clara, CA (US)

(72) Inventors: Srirama Murthy Raju Bhupatiraju, San Jose, CA (US); Shobek Sam Attupurath, Santa Clara, CA (US); Sathish Samson, San Jose, CA (US)

(21) Appl. No.: 18/584,861

(22) Filed: Feb. 22, 2024

(51) Int. Cl. H04B 17/318; H04W 24/10; H04W 28/02

(52) U.S. Cl. CPC H04B 17/318; H04W 24/10; H04W 28/0236

(57) ABSTRACT

In various examples, systems and methods described herein may cause a machine to establish a network connection with a network access device based at least on map data indicating to use the network access device for network connectivity at a location of the machine. In some examples, the map data may be generated based at least on one or more network performance scores associated with one or more network access devices disposed in the environment. In some instances, the network performance score(s) may be determined based at least on one or more wireless network signals transmitted by the network access device(s) and obtained using the machine and/or another machine. The network performance score(s) may, in some examples, be indicative of a signal strength associated with the network access device(s) at the location of the machine.

### BACKGROUND

Today's wireless networks may include one or more access points, allowing wireless-enabled devices to establish and/or maintain strong network connectivity regardless of device location. Such wireless networks may support wireless roaming, which allows a connected device to change access points based on signal strength. For instance, as the connected device moves within a coverage area of the wireless network, the connection/signal between the connected device and its current access point may fail and/or become weak. As a result, when the connection/signal strength fails or falls below a threshold, a roam event may be triggered and the device may begin to scan for available access points and/or listen for beacon frames broadcasted by nearby access points. The device may evaluate the signal strength of these nearby access points and determine a best candidate access point for roaming or establishing a connection to. The device may then initiate a handoff process and send a request to the new access point to establish the connection, as well as potentially negotiate one or more parameters such as authentication and encryption settings.

However, as part of the roaming process described above, wireless devices often spend a considerable amount of time scanning channels to determine candidate access points. This time spent by a wireless device scanning channels may then translate into time that the wireless device may spend off channel, resulting in a pause to the flow of data traffic. Such off-channel behavior and pauses in the flow of data traffic may be problematic in scenarios involving strict latency requirements. Additionally, in some circumstances, even if the connections/signal strengths of the wireless devices do not fail and/or fall below the threshold, the wireless devices may not be connected to the access points that provide for the best connections/signal strengths.

### SUMMARY

Embodiments of the present disclosure relate to location-aware wireless network roaming for robotics systems and applications. For instance, systems and methods described herein may cause a machine to establish a network connection with a network access device based at least on map data associating the network access device with a current location of the machine. Additionally, or alternatively, the systems and methods may cause the machine to initiate a roaming process to move the network connection to a different network access device based at least on changes in location. As described herein, the map data may indicate one or more network access devices for one or more machines to use for network connectivity at respective locations in an environment. In some examples, the map data may be generated based at least on one or more network performance scores associated with the network access device(s). For instance, the network performance score(s) may be determined based at least on one or more wireless network signals transmitted by the network access device(s) and obtained using the machine(s) and/or one or more other machines.

In contrast to conventional systems, the systems of the present disclosure, in some embodiments, are able to initiate a roam event based on machine/device location and establish new access point connections without having to pause the flow of data traffic to perform an off-channel scan(s). As such, and as described in more detail herein, by performing such processes, the current systems are able to identify a best network access device for roaming a connection in fewer attempts, sometimes a single attempt. This provides improvements over the conventional systems that require scanning channels to identify potential roaming candidates, which may require spending a considerable amount of time off channel and/or pausing the flow of data traffic. Additionally, by being location aware and pre-determining ideal roaming candidates based on location, the current systems may be advantageous in scenarios involving strict latency requirements as compared to the conventional systems that induce latency by going off-channel and pausing data traffic flows. Furthermore, the current systems ensure wireless-enabled machines/devices are connected to the best network access since the roaming is performed automatically.

### BRIEF DESCRIPTION OF THE DRAWINGS

The present systems and methods for location-aware wireless network roaming for robotics systems and applications are described in detail below with reference to the attached drawing figures, wherein:

FIG. 1 is a data flow diagram illustrating an example process of generating network mapping data, in accordance with some embodiments of the present disclosure;

FIG. 2A illustrates an example map of an environment, in accordance with some embodiments of the present disclosure;

FIG. 2B illustrates example network map data overlayed on the map of FIG. 2A, in accordance with some embodiments of the present disclosure;

FIGS. 3A and 3B are data flow diagrams collectively illustrating an example process of roaming a wireless network connection based on location, in accordance with some embodiments of the present disclosure;

FIG. 4 illustrates a machine traversing the environment represented in the map and roaming its network connection based on location, in accordance with some embodiments of the present disclosure;

FIG. 5 is a flow diagram illustrating an example method associated with generating mapping data for location aware wireless network roaming, in accordance with some embodiments of the present disclosure;

FIG. 6 is a flow diagram illustrating an example method associated with location aware wireless network roaming, in accordance with some embodiments of the present disclosure;

FIG. 7A is an illustration of an example autonomous vehicle, in accordance with some embodiments of the present disclosure;

FIG. 7B is an example of camera locations and fields of view for the example autonomous vehicle of FIG. 7A, in accordance with some embodiments of the present disclosure;

FIG. 7C is a block diagram of an example system architecture for the example autonomous vehicle of FIG. 7A, in accordance with some embodiments of the present disclosure;

FIG. 7D is a system diagram for communication between cloud-based server(s) and the example autonomous vehicle of FIG. 7A, in accordance with some embodiments of the present disclosure;

FIG. 8 is a block diagram of an example computing device suitable for use in implementing some embodiments of the present disclosure; and

FIG. 9 is a block diagram of an example data center suitable for use in implementing some embodiments of the present disclosure.

### DETAILED DESCRIPTION

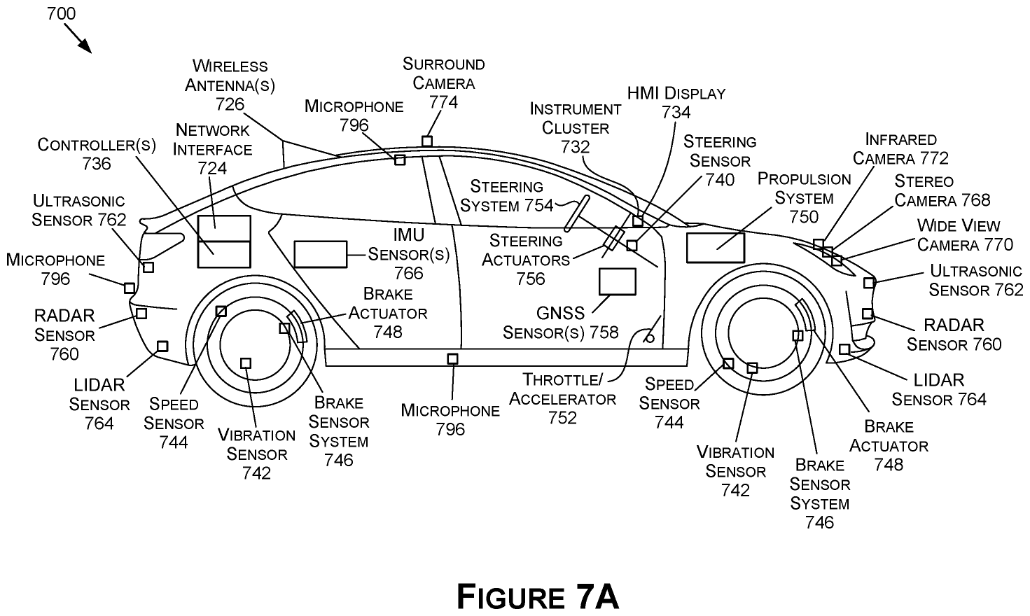

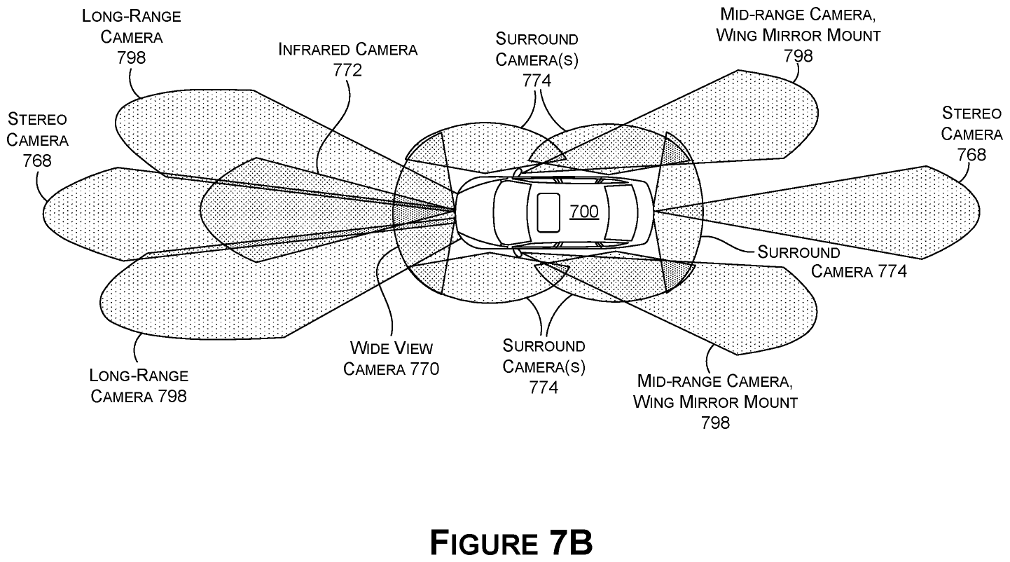

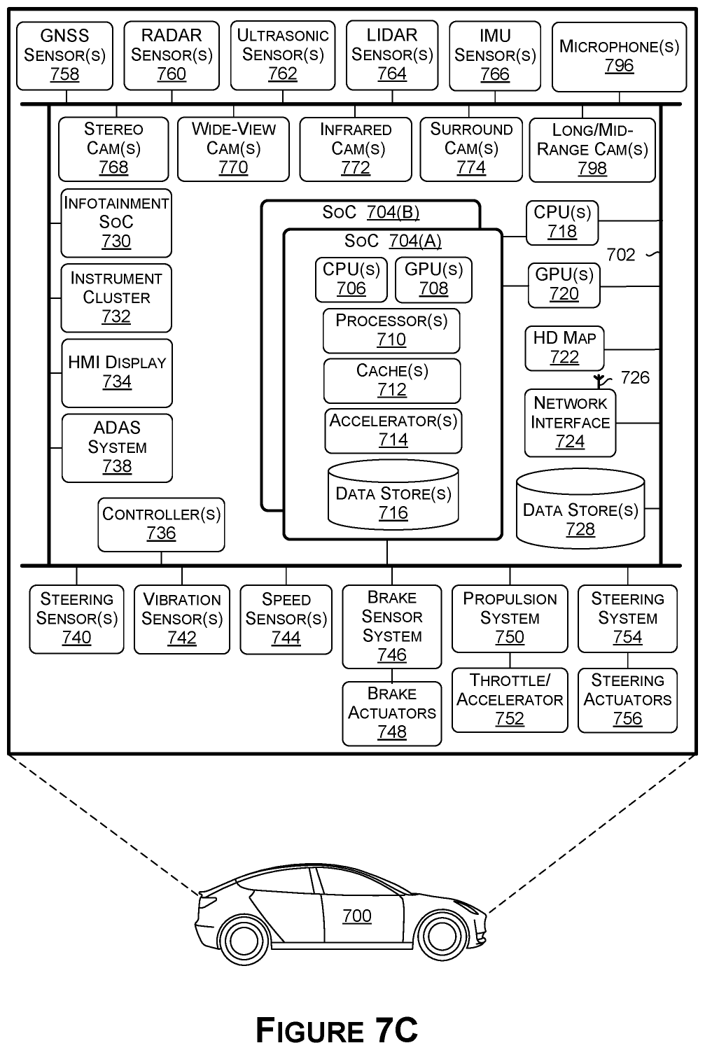

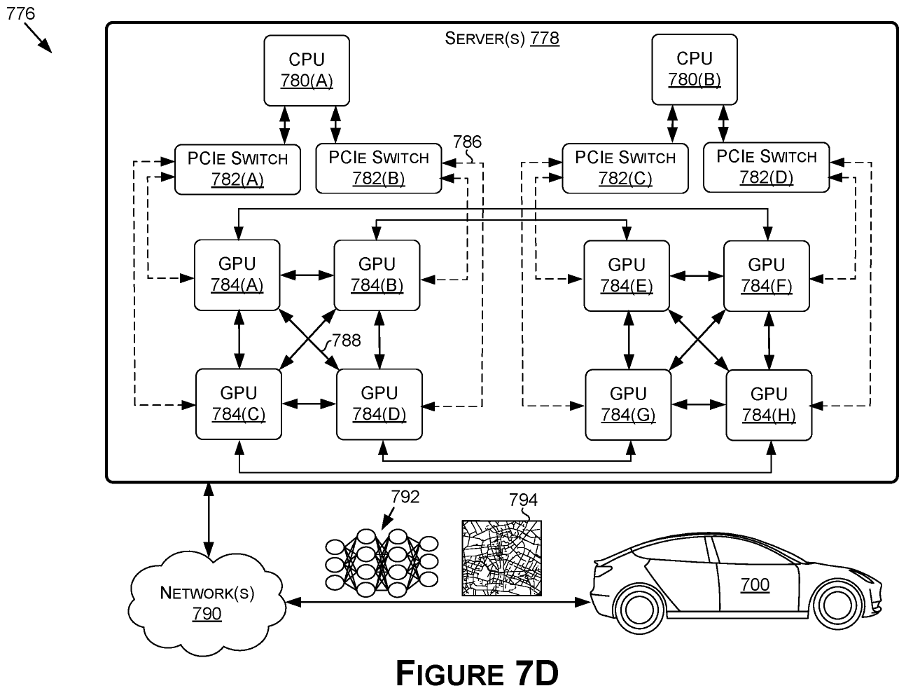

Systems and methods are disclosed related to location-aware wireless network roaming for robotics systems and applications. Although the present disclosure may be described with respect to an example autonomous or semi-autonomous vehicle or machine 700 (alternatively referred to herein as “vehicle 700,” “ego-vehicle 700,” “ego-machine 700,” or “machine 700,” an example of which is described with respect to FIGS. 7A-7D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to location-based wireless network roaming for wireless-enabled machines and/or devices, this is not intended to be limiting, and the systems and methods described herein may be used in augmented reality, virtual reality, mixed reality, robotics, security and surveillance, autonomous or semi-autonomous machine applications, and/or any other technology spaces where wireless network roaming may be used.

For instance, a system(s) may generate map data associated with an environment. In some examples, the map data may include first map data (e.g., a base map, such as a standard-definition (SD) map, a high-definition (HD) map, a building layout map, and/or any other type of map) representing the environment and second map data (e.g., network roaming map) indicating one or more network access devices (e.g., a Wi-Fi access point(s), etc.) to use for network connectivity at one or more locations (e.g., coordinates, areas, regions, tiles, etc.) in the environment. For instance, the second map data may indicate to use a first network access device for network connectivity at a first location in the environment and to use a second network access device for network connectivity at a second location in the environment. In some examples, the second map data may be a map layer that is overlayed on top of the first map data (e.g., overlayed on top of the base map). In this way, the first map data may be used for one or more first purposes (e.g., localization) and the second map data may be used for one or more second purposes (e.g., wireless network roaming).

As described herein, the second map data may be determined and/or generated in a number of ways. For instance, in some examples, the second map data may be generated based on a coverage map (e.g., Wi-Fi coverage map or other networking coverage map—e.g., Bluetooth, LoRaWAN, etc.). Such coverage map may, in some instances, be obtained from an information technology (IT) system. Additionally, or alternatively, in some examples, the system(s) may generate the second map data based on network-related data obtained by one or more machines (e.g., autonomous machines) operating in the environment.

For example, the system(s) may cause the machine(s) to traverse the environment. While traversing the environment, the machine(s) may obtain network-related data associated with a network (e.g., Wi-Fi network) in the environment by connecting to various network access points and monitoring roam triggers in association with the current location of the machine(s). For instance, while at a first location in the environment, the machine(s) may perform a first wireless network scan to determine one or more network access devices capable of being used for network connectivity at the first location. The machine(s) may then move to a second location in the environment and perform a second wireless network scan to determine the network access device(s) capable of being used for network connectivity at the second location. In some examples, this process of moving, scanning, and determining network access device(s) for connectivity may be repeated until sufficient data has been obtained, such as until the machine(s) has covered a threshold amount of the environment, until wireless network coverage has been determined for a threshold amount of the environment, and/or in response to any other coverage events being satisfied.

In some examples, for the wireless network scan(s) performed at the various locations, the system(s) may determine a best network access device for a location. For example, during the wireless network scan, the machine(s) may obtain wireless networking data (e.g., signals, etc.) from the network access device(s). The wireless networking data may, in some examples, be used to determine one or more network performance scores associated with the network access device(s) at the various locations. For instance, for the first location, the system(s) may determine a first network performance score associated with a first network access device and a second network performance score associated with a second network access device based at least on the wireless networking data. The system(s) may then determine that the first network performance score is greater than the second network performance score and, as such, select the first network access device for association with the first location. Likewise, for a second location, the system(s) may determine a third network performance score associated with the first network access device and a fourth network performance score associated with the second network access device based at least on the wireless networking data. The system(s) may then determine that the fourth network performance score is greater than the third network performance score and, as such, select the second network access device for association with the second location. The system(s) may continue to repeat this process for the various locations to select the best network access device for network connectivity at the various locations.

Additionally, in some examples, the system(s) may determine primary and secondary (e.g., backup) network access devices to use for network connectivity at the location(s) in the environment. For instance, in the first location described just above, the system(s) may select the second network access device to be used as a secondary (e.g., backup) access device to the first network access device. In this way, if a failure condition occurs with the first network access device (e.g., loss of signal, low bandwidth, etc.) and/or the network performance score drops below a threshold (e.g., a threshold amount below the second network performance score), then the second network access device may be used for network connectivity. In some examples, the second map data may include or otherwise indicate the primary and secondary network access devices associated with the location(s).

In some examples, the system(s) may determine the network performance score(s) based on various attributes associated with the network access device(s). For instance, the network performance score(s) may be determined based at least on one or more signal strengths associated with the network access device(s) at the location(s). For example, the greater the signal strength the greater the network performance score may be, and the lower the signal strength the lower the network performance score may be, in some instances. Additionally, or alternatively, the network performance score(s) may be determined based at least on one or more bandwidth availabilities associated with the network access device(s). Furthermore, other attributes that may contribute to the network performance score(s) may include, but are not limited to, latency, packet loss, jitter, reliability, and/or throughput. In some examples, the network performance score(s) may be determined based on various combinations of the attributes described above and herein, and the various attributes may be weighted differently in various examples (e.g., more deference may be given to signal strength than bandwidth, etc.). In this way, the network performance score(s) may be configured to indicate more than a single attribute (e.g., signal strength) and can convey more insightful information. As an example, based on the network performance score(s), the system(s) may determine to use a network access device with a lower signal strength but a higher available bandwidth, etc.

In some embodiments, the selected access point may be determined based on identified conditions in the environment. For example, when certain objects (dynamic and/or static) are present at a particular location, a first access point may be better than a second access point. In contrast, when the object(s) are not present, the second access point may be better. As such, perception of the machine may be used in combination with the location on the map to determine the access point to connect to at any particular time. As non-limiting examples, when a certain room in a building is occupied by some threshold number of people, and/or when the room (e.g., machine lab) has machinery currently in use, the signal strength and/or bandwidth for one or more access points may be impacted. As such, this information may be learned over time, and using the perception system of the machine (or other information determined using the machine), the determination of the access point to use at a particular location and in view of current circumstances may be made.

In addition to generating the map data for wireless network roaming, the techniques disclosed herein also include using the map data for wireless network roaming. For instance, in some examples, the system(s) may provide the map data, including both the first map data and the second map data, to one or more second machines, and the second machine(s) may use the map data to traverse the environment. In some examples, the second machine(s) may be similar to the machine(s) described above, and the second machine(s) that obtains the map data from the system(s) may, in some instances, be the same machines the system(s) used to generate the map data. In examples, the machine(s) may synchronize with the system(s) to obtain the map data, and the machine(s) may use the map data to initiate wireless network roaming while traversing the environment.

For example, while a machine is traversing the environment, the machine may determine its current location relative to the environment represented in the map data. For instance, the machine (e.g., a localization system of the machine) may determine the current location based at least on sensor data and/or the map data. In some examples, the machine may establish a first network connection with a first network access device based at least on the map data associating the first network access device with the current location of the machine. As the machine continues to traverse the environment, the machine may continuously determine and/or update its current location relative to the environment represented in the map data. The machine may then establish a second network connection with a second network access device based at least on the map data associating the second network access device with the updated location of the machine. This process may continue to repeat as the machine traverses the environment such that the machine may continue to use the map data and establish new network connections with different network access devices when the location of the machine changes.

In some examples, the machine may determine to roam its network connection even when the location of the machine has not changed. For example, if the machine is connected to the first network access device and determines that the network performance score of the first network access device has fallen below a threshold, the machine may establish a connection with the second network access device, which may be the secondary access device for that location or identified based on a scan. Additionally, in some examples, the machine may cause the map data to be updated to reflect that the second network access device is to be used as the primary access device for the location. In this way, the map data may be dynamically updated so that other machines can quickly roam between network access points without having to potentially spend an unreasonable amount of time off-channel.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

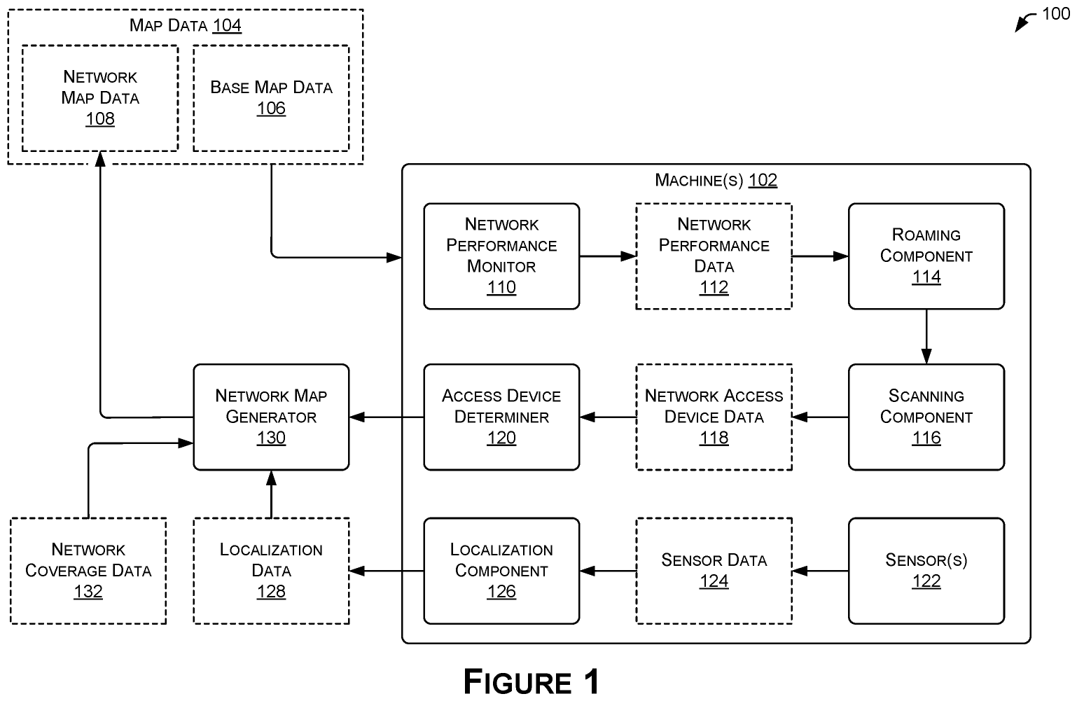

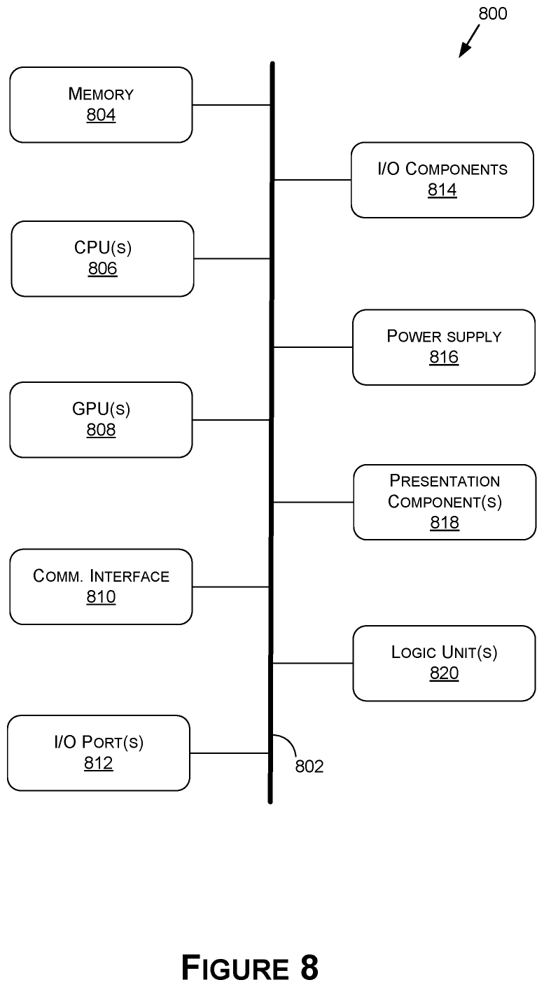

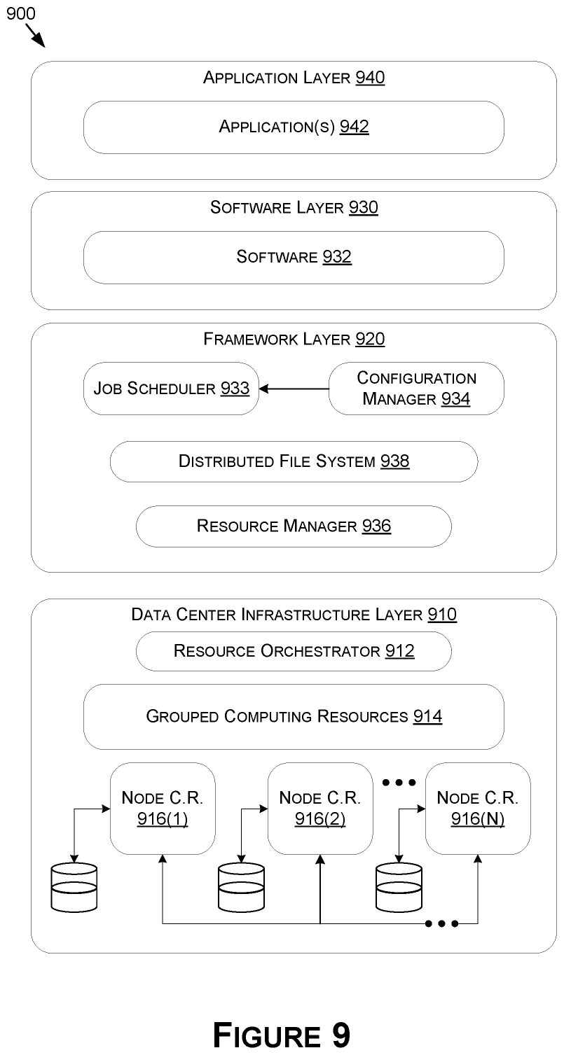

With reference to FIG. 1, FIG. 1 is a data flow diagram illustrating an example process 100 of generating network map data, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 700 of FIGS. 7A-7D, example computing device 800 of FIG. 8, and/or example data center 900 of FIG. 9.

The process 100 may include one or more machines (e.g., a machine(s) 102) that obtain map data 104. In some examples, the machine(s) 102 may include, or otherwise be associated with, a network performance monitor 110, a roaming component 114, a scanning component 116, an access device determiner 120, one or more sensors (e.g., a sensor(s) 122), and a localization component 126. In some examples, and as described in further detail below, the network performance monitor 110, the roaming component 114, the scanning component 116, the access device determiner 120, the sensor(s) 122, and the localization component 126 may perform various operation(s) on behalf of the machine(s) 102, for instance, while the machine(s) 102 is traversing an environment.

As shown, the map data 104 may include, or otherwise be associated with, base map data 106 and network map data 108. In some examples, the base map data 106 may represent an environment the machine(s) 102 is to operate in. In some examples, the machine(s) 102 may be used to update the network map data 108. For instance, the machine(s) 102 may traverse the environment using the map data 104 and network-related data obtained by the machine(s) 102 may be used to update features in the network map data 108. Additionally, or alternatively, in some instances the map data 104 may, at least initially, include a limited or basic version of the network map data 108 and/or not include the network map data 108 at all. That is, in some examples, the machine(s) 102 may initially traverse the environment using the base map data 106 and/or other data (e.g., the sensor data 124, the localization data 128, etc.). In this way, and as described herein, the machine(s) 102 may obtain network-related data (e.g., the network performance data 112, the network access device data 118, etc.) associated with the environment such that the network map data 108 may be generated.

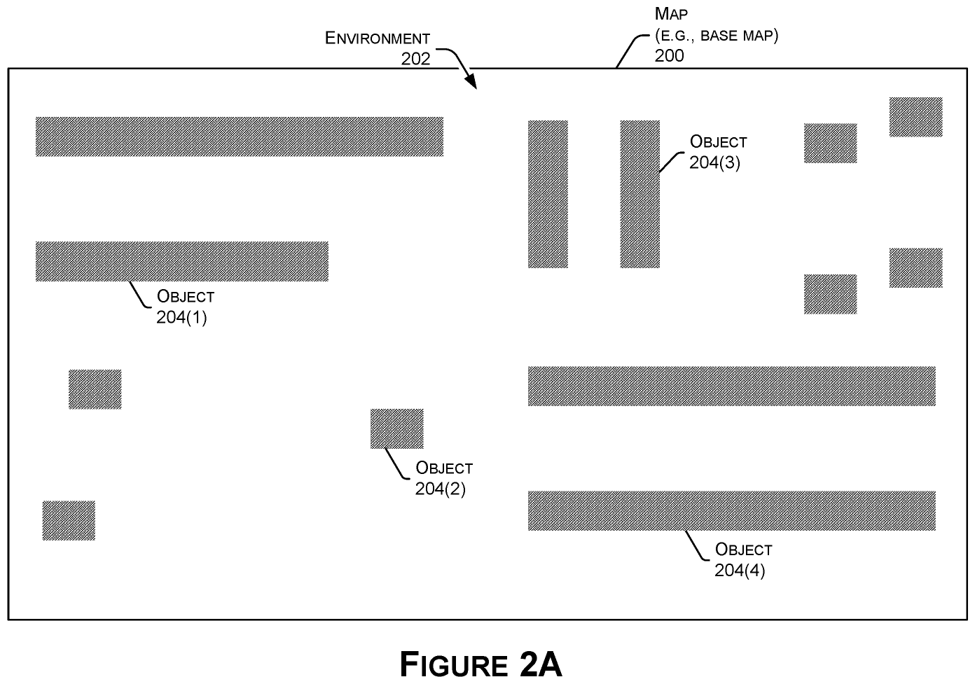

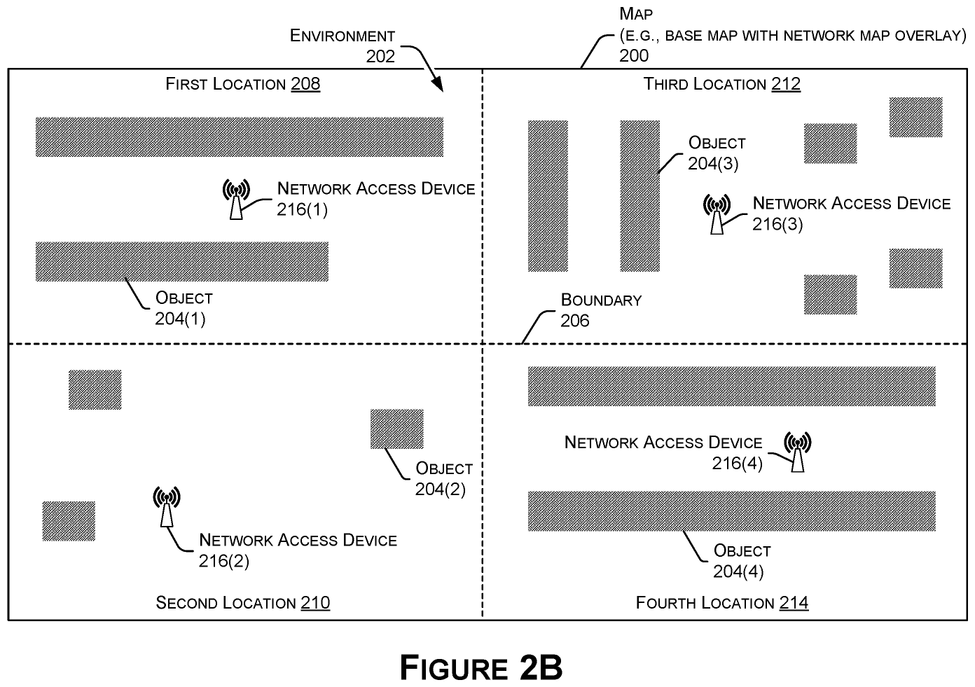

For instance, FIG. 2A illustrates an example map 200 of an environment 202, in accordance with some embodiments of the present disclosure. The map 200 illustrated in the example of FIG. 2A may correspond with map data 104 that includes the base map data 106 and excludes the network map data 108. The environment 202 represented by the map 200 may include one or more objects, such as the objects 204(1)-204(4) (hereinafter referred to collectively as “objects 204”). In some examples, the map 200, as well as the map data 104, may be associated with sensor data used to generate the map (e.g., generate one or more layers of the map, such as the base map data 106). As described herein, the sensor data may include, but is not limited to, RADAR data generated using one or more RADAR sensors, LiDAR data generated using one or more LiDAR sensors, image data generated using one or more image sensors (e.g., one or more cameras), and/or any other type of sensor data generated using any other type of sensor. For instance, the objects 204 represented in the map 200 may be LiDAR points, RADAR points, image points, etc. Additionally, the sensor data may be generated using the machine(s) 102 navigating within the environment 202. For instance, the sensor data 124 obtained by the sensor(s) 122 of the machine(s) 102 may be used to generate the map 200, including the map data 104 and/or the base map data 106.

Referring back to the example of FIG. 1, the process 100 may include the network performance monitor 110 of the machine(s) 102 determining network performance data 112. The network performance data 112 may include, among other things, a network performance score associated with a network access device at a current location of the machine(s) 102. For instance, while the machine(s) 102 is at a first location in the environment, the machine(s) 102 may have a first network connection with the first network access device to facilitate network connectivity. As such, while the machine(s) 102 moves within the environment (e.g., from the first location to one or more second locations), the network performance monitor 110 may determine the network performance data 112 (e.g., a network performance score) associated with the first network access device. The network performance data 112 may be indicative of various information associated with the first network access device and/or the first network connection at the current location of the machine(s) 102, including, but not limited to, signal strength, bandwidth, latency, packet loss, congestion, interference, and/or throughput.

In some examples, the process 100 may include the roaming component 114 of the machine(s) 102 obtaining the network performance data 112 from the network performance monitor 110. In some instances, the roaming component 114 may analyze the network performance data 112 to determine whether to roam a wireless network connection of the machine(s) 102. That is, the roaming component 114 may determine, based at least on the network performance data 112, whether to initiate a roaming process to migrate the wireless network connection from the first network access device (e.g., the current network access device) to a second network access device. For instance, if the network performance data 112 indicates that a network performance score associated with the first network access device is below a threshold at the current location of the machine(s) 102, then the roaming component may initiate the roaming process. In some examples, network performance score(s) may be below the threshold for a number of reasons, including, but not limited to, weak signal strength, low bandwidth, high latency, high packet loss, high congestion, high interference, and/or low throughput.

In some examples, if the roaming component 114 determines to initiate the roaming process, the process 100 may proceed from the roaming component 114 to the scanning component 116 of the machine(s) 102. The scanning component 116 may scan the environment for candidate network access devices to roam the network connection to, and determine network access device data 118 based at least on wireless networking data (e.g., wireless signals) obtained during the scanning process. The wireless networking data may be transmitted by one or more of the network access devices disposed in the environment. In some examples, the network access device data 118 may include information (e.g., network performance scores) associated with the candidate network access devices in order to determine the best candidate network access device for roaming the connection to at the location of the machine(s) 102. For instance, the information may include, for each candidate network access device, a signal strength at the location, a bandwidth availability, a throughput, and/or other information. In some examples, the information included in the network access device data 118 may be organized by Service Set Identifier (SSID). That is, the network access device data 118 may indicate, for each candidate network access device, an SSID and its respective information (e.g., signal strength, bandwidth, etc.)

In some examples, the scanning component 116 may perform a full scan or a partial scan. For instance, the scanning component 116 may, in some examples, comprehensively scan each channel to determine candidate network access devices. Additionally, or alternatively, the scanning component 116 may obtain an 802.11k neighbor report (e.g., from its current network access device) and, as such, scan a smaller number of channels based on the report.

The process 100 may also include the access device determiner 120 obtaining the network access device data 118. The access device determiner 120 may analyze the network access device data 118 to determine a best network access device for roaming the networking connection to. For instance, the access device determiner 120 may determine, based on the network access device data 118 and/or a network performance score included therein, which network access device of the candidates has the greatest signal strength at the location of the machine(s) 102. Additionally, or alternatively, the access device determiner 120 may determine which network access device of the candidates has the greatest network characteristic value (e.g., indicating best bandwidth, latency, packet loss, jitter, throughput, availability, etc.). Additionally, in some examples, the access device determiner 120 may determine a secondary network access device of the candidates to use as a backup at the current location of the machine(s) 102. In some examples, the access device determiner 120 may output a ranked list of network access devices for the machine(s) 102 to use for network connectivity at the location (e.g., a primary device, secondary device, tertiary device, etc.).

The process 100 may include the network map generator 130 generating the network map data 108 and/or updating the map data 104 with the network map data 108. In some examples, the network map generator 130 may generate the network map data 108 based at least on information obtained from the machine(s) 102. For instance, the network map generator 130 may obtain an indication of one or more network access devices to use for network connectivity from the access device determiner 120 of the machine(s). Additionally, in some examples, the network map generator 130 may obtain localization data 128 from the localization component 126 of the machine(s) 102. For instance, the localization component 126 may determine the localization data 128 based at least on the base map data 106 of the map data and/or sensor data 124 generated by the sensor(s) 122 of the machine(s) 102. The network map generator 130 may then use the localization data 128 to determine one or more locations in the environment where the machine(s) 102 are to use the network access device(s) indicated by the access device determiner 120. In some examples, the network map generator 130 may include one or more components of the machine(s) 102 in addition to, or alternatively from, the machine(s) 102. For instance, the network map generator 130 may determine the best network access devices to use in various locations using the components and/or the processes described above and herein as pertaining to, and/or being performed by, the machine(s) 102.

Additionally, in some examples, the network map generator 130 may generate the network map data 108 based at least on network coverage data 132 (e.g., Wi-Fi coverage map or other networking coverage map), which may be obtained from one or more IT systems. In some examples, the network coverage data 132 may indicate one or more locations where one or more network access devices are disposed in the environment. Additionally, in some examples, the network coverage data 132 may indicate one or more attributes associated with the network access device(s), such as signal strength, bandwidth, frequency, number of channels, range, etc. The network coverage data 132 may also indicate a coverage area for the network access device(s). That is, the network coverage data 132 may, in some examples, indicate a location, area, region, etc. in the environment where a signal strength of the network access device(s) is expected to be above a threshold.

The network map generator 130 may also generate the network map data 108 and include features in the network map data 108 associating the best network access device(s) with respective location(s). For instance, FIG. 2B illustrates the map 200 including example features of the network map data 108 overlayed on the base map data 106 features, in accordance with some embodiments of the present disclosure. In some examples, the features of the network map data may include one or more boundaries, such as the boundary 206 which divides the environment 202 into various locations (e.g., sections, areas, regions, tiles, etc.). For instance, the boundary 206 in the example of FIG. 2B effectively divides the environment 202 represented in the map 200 into a first location 208, a second location 210, a third location 212, and a fourth location 214. While the example of FIG. 2B illustrates the locations 208, 210, 212, and 214 as including rectangular shaped areas, in other examples, the locations 208, 210, 212, and 214 may include any other shaped areas and/or arbitrarily shaped areas.

Additionally, and still with reference to FIG. 2B, the network map data features of the map 200 may include locations of one or more network access devices in the environment 202, such as the network access devices 216(1)-216(4) (hereinafter referred to collectively as “network access devices 216”). In examples, the network access devices 216 may be associated with the different locations in the network map data. That is, the network map data features in the map 200 may indicate which network access device to use for network connectivity in each location. For instance, a first network access device 216(1) is to be used for network connectivity in the first location 208, a second network access device 216(2) is to be used for network connectivity in the second location 210, a third network access device 216(3) is to be used for network connectivity in the third location 212, and a fourth network access device 216(4) is to be used for network connectivity in the fourth location 214.

In some examples, the network map data features may indicate primary and secondary (e.g., backup) network access devices to use for network connectivity. For instance, the second network access device 216(2) may be used as a secondary/backup device to the first network access device 216(1) in the first location 208. Similarly, the first network access device 216(1) may be used as a secondary/backup device to the second network access device 216(2) in the second location 210. In this way, if a failure condition occurs and/or network performance drops below a threshold, then the secondary/backup network access device may be used for network connectivity. Similarly, two or more network access devices 216 may be assigned to a particular location with various other criteria associated therewith—e.g., current number of occupants in the space, machinery activated in the space, density of supplies on shelves, etc. As such, using perception of the machine or other gathered information (e.g., from an indoor or outdoor camera system or network, weight or heat sensors, etc.), the determination of the particular network access device 216 may be made.

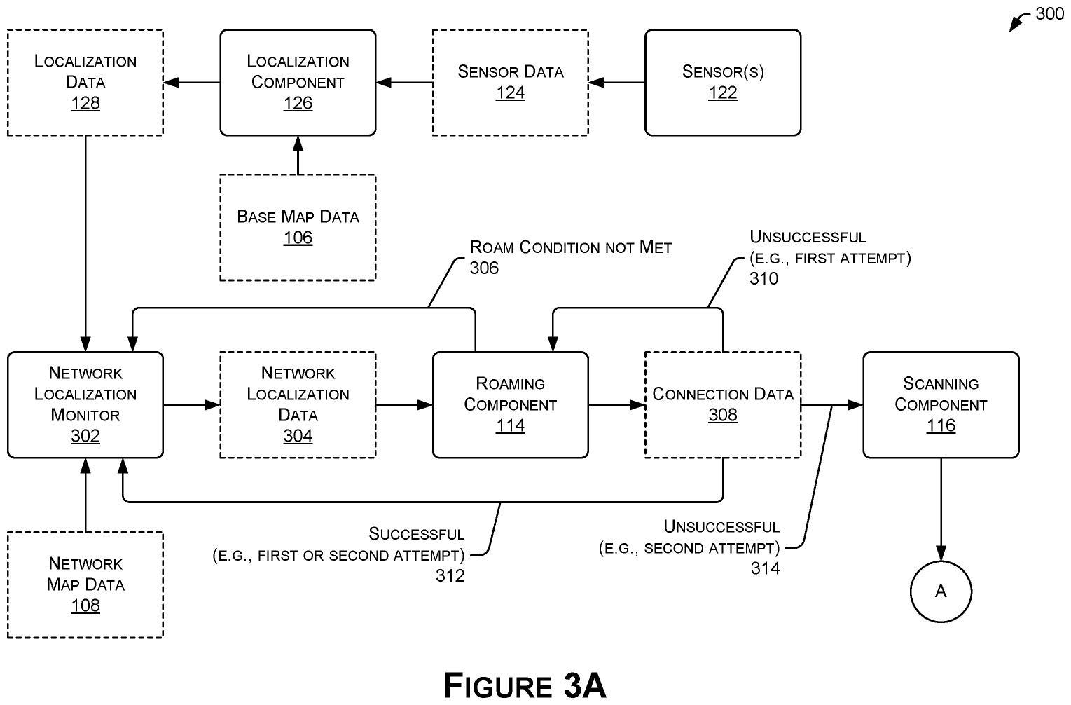

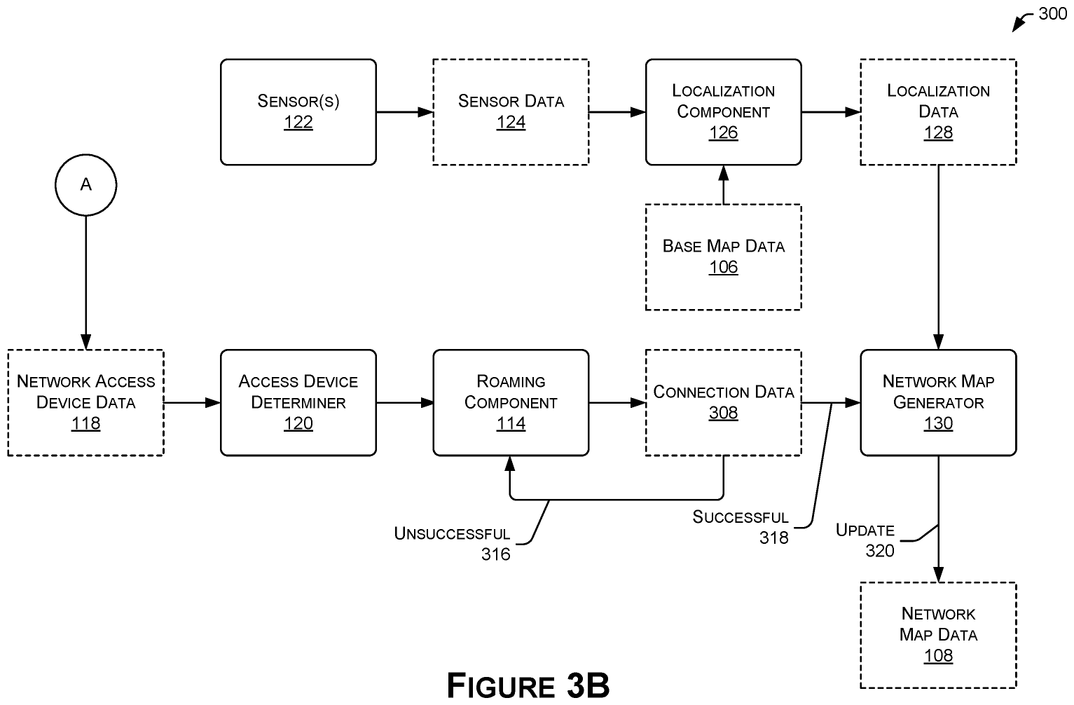

FIGS. 3A and 3B are data flow diagrams collectively illustrating an example process of roaming a wireless network connection based on location, in accordance with some embodiments of the present disclosure. For illustration purposes, the machine(s) 102 is omitted from FIGS. 3A and 3B. However, it is to be understood that various operations of the process 300 may be performed by the machine(s) 102 described above and herein, and various components included in FIGS. 3A and 3B may be components of the machine(s) 102.

With reference to FIG. 3A, the process 300 may include a network localization monitor 302 that obtains the localization data 128 and the network map data 108 and determines network localization data 304. That is, the network localization monitor 302 may determine a current location of the machine(s) 102, as indicated in the localization data 128, relative to the network map data 108, and the network localization data 304 may be indicative of whether the machine(s) is to roam the network connection. In some examples, the localization data 128 may be determined by the localization component 126 based at least on the base map data 106 and/or the sensor data 124 generated by the sensor(s) 122.

In some examples, the process 300 may include the roaming component 114 obtaining the network localization data 304 and determining, based on the network localization data 304, whether to initiate the roaming process. For instance, if the roaming component 114 determines, based on the network localization data 304, that a roaming condition has not been met 306 (e.g., location has not changed), then the process 300 may return to the network localization monitor 302. However, if the roaming component 114 determines the roaming condition is met, the roaming component may initiate the roam and attempt to establish a connection with the appropriate network access device based on the network map data 108. In examples, the roaming component 114 may output connection data 308 associated with the new connection being established during the roam process.

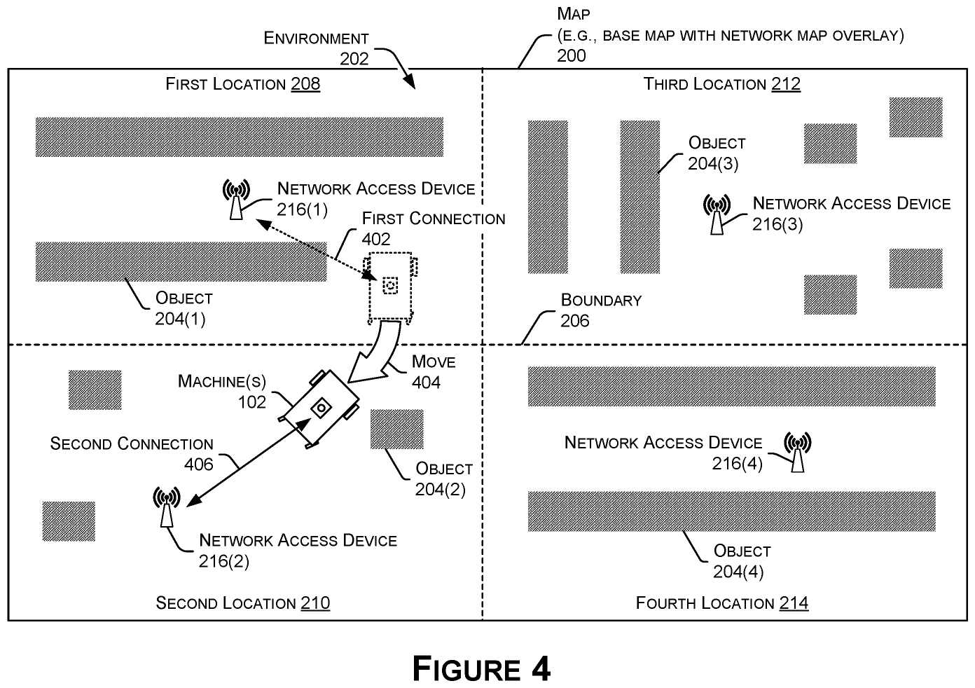

For instance, FIG. 4 is an illustration of the machine(s) 102 traversing the environment 202 represented in the map 200 and roaming its network connection based on location, in accordance with some embodiments of the present disclosure. The broken line representation of the machine(s) 102 in FIG. 4 corresponds to a previous location of the machine(s) 102, and the solid line representation of the machine(s) 102 corresponds to a present location of the machine(s) 102. As illustrated in FIG. 4, when the machine(s) 102 was located at the previous location corresponding with the first location 208, the machine(s) 102 maintained network connectivity using a first connection 402 with the first network access device 216(1). However, when the machine(s) 102 moved 404 from its previous location to its present location corresponding with the second location 210, the machine(s) 102 established a second connection 406 with the second network access device 216(2) to maintain network connectivity. That is, instead of the machine(s) 102 monitoring its signal strength of the first connection 402 and initiating the roaming process when the signal strength was below a threshold and/or failing, the machine(s) 102 monitored its location relative to the map 200 and, when the machine(s) 102 crossed the boundary 206 and entered the second location 210, the machine(s) 102 initiated the roaming process to establish the second connection 406.

Referring back to FIG. 3A, in some examples, the roaming component 114 may initially attempt to connect the machine(s) 102 to a primary network access device as indicated in the network map data 108. However, if the connection data 308 indicates that the attempted connection is unsuccessful 310 during this first attempt, the process 300 may proceed back to the roaming component 114. The roaming component 114 may then attempt to establish a connection with a secondary network access device as indicated in the network map data 108. If either one of the first connection attempt or the second connection attempt is successful 312, then the process 300 may proceed back to the network localization monitor 302. However, if the connection data 308 indicates that the second connection attempt was also unsuccessful 314, then the process 300 may proceed to the scanning component 116 to begin looking for a network access device to connect to.

In some examples, the scanning component 116 may scan the environment for candidate network access devices to roam the network connection to and, turning with reference to FIG. 3B, determine network access device data 118 based at least on wireless networking data (e.g., wireless networking signals) obtained during the scanning process. The wireless networking data may be transmitted by one or more of the network access devices disposed in the environment. In some examples, the network access device data 118 may include information (e.g., network performance scores) associated with the candidate network access devices in order to determine the best candidate network access device for roaming the connection to at the location of the machine(s) 102. For instance, the information may include, for each candidate network access device, a signal strength at the location, a bandwidth availability, a throughput, and/or other information. In some examples, the information included in the network access device data 118 may be organized by Service Set Identifier (SSID). That is, the network access device data 118 may indicate, for each candidate network access device, an SSID and its respective information (e.g., signal strength, bandwidth, etc.)

In some examples, the scanning component 116 may perform a full scan or a partial scan. For instance, the scanning component 116 may, in some examples, comprehensively scan each channel to determine candidate network access devices. Additionally, or alternatively, the scanning component 116 may obtain an 802.11k neighbor report (e.g., from its current network access device) and, as such, scan a smaller number of channels based on the report.

The process 300 may also include the access device determiner 120 obtaining the network access device data 118. The access device determiner 120 may analyze the network access device data 118 to determine the best network access device for roaming the network connection to. For instance, the access device determiner 120 may determine, based on the network access device data 118, which network access device of the candidates has the greatest signal strength, bandwidth, availability, etc. at the location of the machine(s) 102. Additionally, the access device determiner 120 may determine a secondary network access device of the candidates to use as a backup at the current location of the machine(s) 102. In some examples, the access device determiner 120 may output a ranked list of network access devices for the machine(s) 102 to use for network connectivity at the location (e.g., a primary device, secondary device, tertiary device, etc.).

Then, the process 300 may include the roaming component 114 attempting to establish the network connection with one or more of the network access devices identified by the access device determiner 120. In doing so, the roaming component 114 may determine the connection data 308, which may indicate whether or not the network connection was made with the network access device successfully. If the connection data 308 indicates the connection was unsuccessful 316, the process 300 may return back to the roaming component 114 to attempt another connection (e.g., with the same network access device or a different network access device). However, if the connection data 308 indicates the connection was successful 318, the process 300 proceeds to the network map generator 130.

In some examples, the network map generator 130 may obtain the connection data 308 and the localization data 128. The localization data 128 may be determined by the localization component 126 based at least on the base map data 106 and/or the sensor data 124 generated by the sensor(s) 122. In some examples, the network map generator 130 may update 320 the network map data 108 based at least on the connection data 308 and the localization data 128. For instance, the network map generator may obtain an indication, from the connection data 308, of the network access device to use for network connectivity. Additionally, the network map generator 130 may obtain, from the localization data 128, an indication of the current location of the machine(s) 102. The network map generator 130 may then associate the network access device and the location of the machine(s) 102 in the network map data 108.

Turning again with reference to FIG. 4, the system(s) disclosed herein may be configured to determine locations of the network access devices 216 in the environment 202, and update those locations in the network map data features. For instance, as the machine(s) 102 move 404 within the environment 202, the machine(s) 102 may obtain signal strength data associated with the network access devices 216. Using this signal strength data obtained using the machine(s) 102, the system(s) may associate the signal strength data with localization data to determine a specific location(s) in the environment 202 where the signal strength of a network access device is at its peak. The specific location(s) where the signal strength is at its peak may then be used to determine the actual, or approximate, location of the network access devices 216.

Additionally, in some examples, the system(s) may determine the boundary 206 associated with the locations (e.g., the first location 208, the second location 210, etc.) relative to the network performance scores of the network access devices 216. While the network performance score may be based on several different attributes, for case of illustration and understanding, the following example will be explained in terms of signal strength. As such, the boundary 206 associated with the locations may be determined relative to the signal strength associated with the network access devices 216 at the various locations throughout the environment 202. In examples, the boundary 206 may be generated based at least on a signal strength heat map associated with the environment 202. Accordingly, and with reference to FIG. 4, the signal strength of the network access device 216(1) may vary within the first location 208. For instance, the closer the machine(s) 102 is to the location of the network access device 216, the greater the signal strength, and the closer the machine(s) 102 is to the boundary 206, the weaker the signal strength. However, this is merely an example and other factors, such as walls, objects, and other obstructions can affect signal strength. But, to continue the example, the closer the machine(s) 102 gets to the boundary 206 of the first location 208, the stronger the signal strength of the network access devices 216(2)-216(2) may become. However, according to the techniques disclosed herein, while the machine(s) 102 is within the first location 208, the signal strength of the network access device 216(1) may be greater, at least on average, than the neighboring network access devices. In any event, if the signal strength(s) changes over time (e.g., based on changes to the network, changes in the environment, changes to hardware, etc.), the techniques disclosed herein may account for the change(s) an update the network map data accordingly so that a best Quality of Service (QOS) may be achieved throughout the environment.

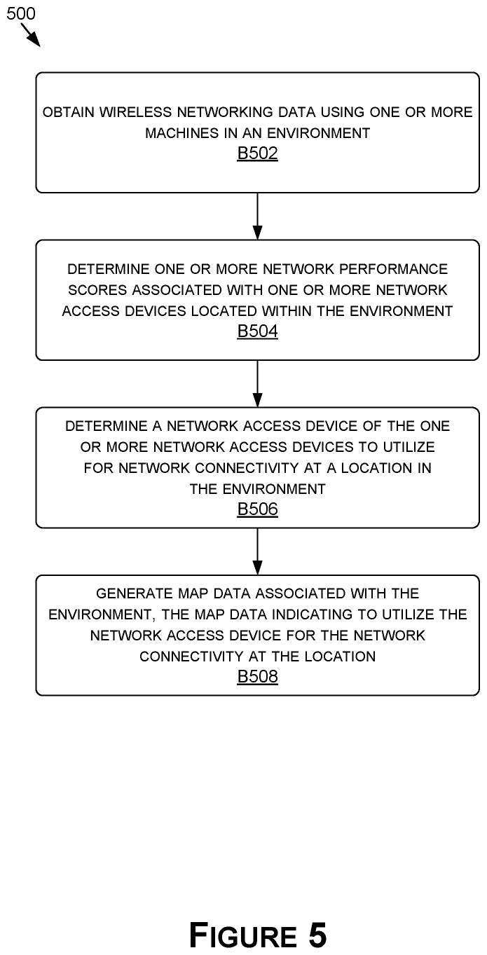

Now referring to FIG. 5, each block of method 500, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 500 is described, by way of example, with respect to FIG. 1. However, these methods may additionally or alternatively be executed by any one system, or any combination of systems, including, but not limited to, those described herein.

FIG. 5 is a flow diagram illustrating an example method 500 associated with generating mapping data for location aware wireless network roaming, in accordance with some embodiments of the present disclosure. The method 500, at block B502, may include obtaining wireless networking data using one or more machines in an environment. For instance, the scanning component 116 may obtain the wireless networking data using the machine(s) 102 in the environment.

The method 500, at block B504, may include determining one or more network performance scores associated with one or more network access devices located within the environment. For instance, the access device determiner 120 may determine the network performance score(s) associated with the network access device(s) located within the environment. In some examples, the network performance score(s) may be determined based at least on the wireless networking data. In some examples, the network performance score(s) may be indicative of a signal strength associated with the network access device(s).

The method 500, at block B506, may include determining a network access device of the one or more network access devices to use for network connectivity at a location in the environment. For instance, the access device determiner 120 may determine the network access device to use for the network connectivity at the location in the environment. In some examples, the access device determiner 120 may determine the network access device based at least on a signal strength associated with the network access device at the location. For instance, the signal strength may be greater than a threshold (e.g., −60 dB, −40 dB, etc.) and/or greater than another signal strength associated with another network access device.

The method 500, at block B508, may include generating map data associated with the environment, the map data indicating to use the network access device for the network connectivity at the location. For instance, the network map generator 130 may generate the map data (e.g., the map data 104 and/or the network map data 108) associated with the environment. In some examples, the map data may indicate respective network access devices to use for network connectivity at respective locations in the environment. For instance, the map data may indicate to use a first network access device at a first location and to use a second network access device at a second location. In some instances, the map data may be used to roam between network access points without evaluating signal strength or other network performance criteria associated with the network access points.

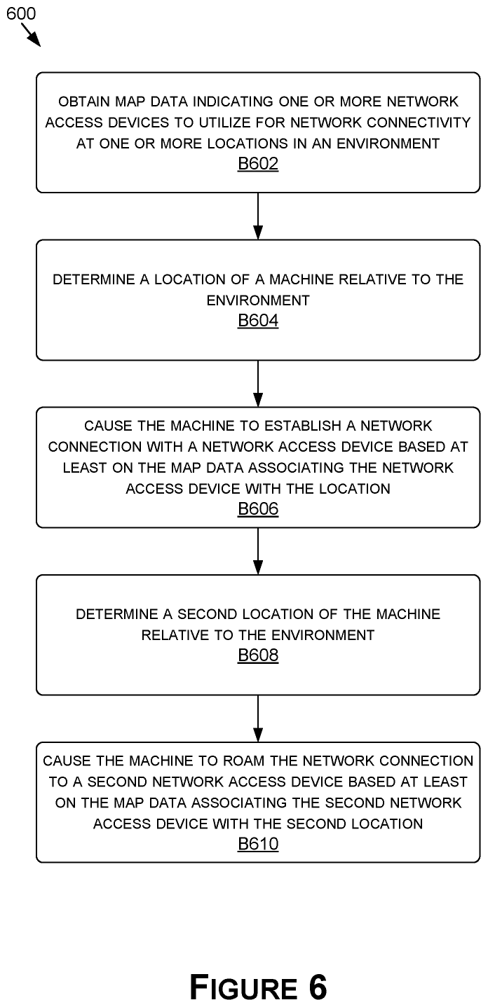

FIG. 6 is a flow diagram illustrating an example method 600 associated with location aware wireless network roaming, in accordance with some embodiments of the present disclosure. The method 600, at block B602, may include obtaining map data indicating one or more network access devices to use for network connectivity at one or more locations in an environment. For instance, the machine(s) 102 may obtain the map data 104. The map data 104 may include the base map data 106 and the network map data 108 indicating the network access device(s) to use for the network connectivity at the location(s) in the environment.

The method 600, at block B604, may include determining a location of a machine relative to the environment. For instance, the localization component 126 of the machine(s) 102 and/or the network localization monitor 302—which may also be associated with the machine(s) 102—may determine the location of the machine(s) relative to the environment represented in the map data 104. In some examples, the location of the machine may be determined relative to the physical environment itself (e.g., represented in the base map data 106) and/or relative to the network environment (e.g., represented in the network map data 108). In some examples, the location of the machine may be determined based at least on sensor data.

The method 600, at block B606, may include causing the machine to establish a network connection with a network access device based at least on the map data associating the network access device with the location. For instance, the roaming component 114 of the machine(s) 102 may cause the machine to establish the network connection with the network access device based at least on the map data 104 associating the network access device with the location of the machine.

The method 600, at block B608, may include determining a second location of the machine relative to the environment. For instance, the localization component 126 of the machine(s) 102 and/or the network localization monitor 302—which may also be associated with the machine(s) 102—may determine the second location (e.g., new location) of the machine relative to the environment represented in the map data 104. In some examples, the second location of the machine may be determined relative to the physical environment itself (e.g., represented in the base map data 106) and/or relative to the network environment (e.g., represented in the network map data 108). In some examples, the second location of the machine may be determined based at least on sensor data.

The method 600, at block B610, may include causing the machine to roam the network connection to a second network access device based at least on the map data associating the second network access device with the second location. For instance, the roaming component 114 of the machine(s) 102 may cause the machine to roam the network connection to the second network access device based at least on the map data 104 associating the second network access device with the second location of the machine. In some examples, roaming the connection may include causing the machine to terminate its connection with the network access device based at least on (e.g., after) establishing a second network connection with the second network access device.

### Example Autonomous Vehicle

FIG. 7A is an illustration of an example autonomous vehicle 700, in accordance with some embodiments of the present disclosure. The autonomous vehicle 700 (alternatively referred to herein as the “vehicle 700”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 700 may be capable of functionality in accordance with one or more of Level 3-Level 5 of the autonomous driving levels. The vehicle 700 may be capable of functionality in accordance with one or more of Level 1-Level 5 of the autonomous driving levels. For example, the vehicle 700 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 700 or other machine, such as being fully autonomous, being highly autonomous, being conditionally autonomous, being partially autonomous, providing assistive autonomy, being semi-autonomous, being primarily autonomous, or other designation.

The vehicle 700 may include components such as a chassis, a vehicle body, wheels (e.g., 2, 4, 6, 8, 18, etc.), tires, axles, and other components of a vehicle. The vehicle 700 may include a propulsion system 750, such as an internal combustion engine, hybrid electric power plant, an all-electric engine, and/or another propulsion system type. The propulsion system 750 may be connected to a drive train of the vehicle 700, which may include a transmission, to enable the propulsion of the vehicle 700. The propulsion system 750 may be controlled in response to receiving signals from the throttle/accelerator 752.

A steering system 754, which may include a steering wheel, may be used to steer the vehicle 700 (e.g., along a desired path or route) when the propulsion system 750 is operating (e.g., when the vehicle is in motion). The steering system 754 may receive signals from a steering actuator 756. The steering wheel may be optional for full automation (Level 5) functionality.

The brake sensor system 746 may be used to operate the vehicle brakes in response to receiving signals from the brake actuators 748 and/or brake sensors.

Controller(s) 736, which may include one or more system on chips (SoCs) 704 (FIG. 7C) and/or GPU(s), may provide signals (e.g., representative of commands) to one or more components and/or systems of the vehicle 700. For example, the controller(s) may send signals to operate the vehicle brakes via one or more brake actuators 748, to operate the steering system 754 via one or more steering actuators 756, to operate the propulsion system 750 via one or more throttle/accelerators 752. The controller(s) 736 may include one or more onboard (e.g., integrated) computing devices (e.g., supercomputers) that process sensor signals, and output operation commands (e.g., signals representing commands) to enable autonomous driving and/or to assist a human driver in driving the vehicle 700. The controller(s) 736 may include a first controller 736 for autonomous driving functions, a second controller 736 for functional safety functions, a third controller 736 for artificial intelligence functionality (e.g., computer vision), a fourth controller 736 for infotainment functionality, a fifth controller 736 for redundancy in emergency conditions, and/or other controllers. In some examples, a single controller 736 may handle two or more of the above functionalities, two or more controllers 736 may handle a single functionality, and/or any combination thereof.

The controller(s) 736 may provide the signals for controlling one or more components and/or systems of the vehicle 700 in response to sensor data received from one or more sensors (e.g., sensor inputs). The sensor data may be received from, for example and without limitation, global navigation satellite systems (“GNSS”) sensor(s) 758 (e.g., Global Positioning System sensor(s)), RADAR sensor(s) 760, ultrasonic sensor(s) 762, LIDAR sensor(s) 764, inertial measurement unit (IMU) sensor(s) 766 (e.g., accelerometer(s), gyroscope(s), magnetic compass(es), magnetometer(s), etc.), microphone(s) 796, stereo camera(s) 768, wide-view camera(s) 770 (e.g., fisheye cameras), infrared camera(s) 772, surround camera(s) 774 (e.g., 360 degree cameras), long-range and/or mid-range camera(s) 798, speed sensor(s) 744 (e.g., for measuring the speed of the vehicle 700), vibration sensor(s) 742, steering sensor(s) 740, brake sensor(s) (e.g., as part of the brake sensor system 746), and/or other sensor types.

One or more of the controller(s) 736 may receive inputs (e.g., represented by input data) from an instrument cluster 732 of the vehicle 700 and provide outputs (e.g., represented by output data, display data, etc.) via a human-machine interface (HMI) display 734, an audible annunciator, a loudspeaker, and/or via other components of the vehicle 700. The outputs may include information such as vehicle velocity, speed, time, map data (e.g., the High Definition (“HD”) map 722 of FIG. 7C), location data (e.g., the vehicle's 700 location, such as on a map), direction, location of other vehicles (e.g., an occupancy grid), information about objects and status of objects as perceived by the controller(s) 736, etc. For example, the HMI display 734 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 700 further includes a network interface 724 which may use one or more wireless antenna(s) 726 and/or modem(s) to communicate over one or more networks. For example, the network interface 724 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 726 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 7B is an example of camera locations and fields of view for the example autonomous vehicle 700 of FIG. 7A, in accordance with some embodiments of the present disclosure. The cameras and respective fields of view are one example embodiment and are not intended to be limiting. For example, additional and/or alternative cameras may be included and/or the cameras may be located at different locations on the vehicle 700.

The camera types for the cameras may include, but are not limited to, digital cameras that may be adapted for use with the components and/or systems of the vehicle 700. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 700 (e.g., front-facing cameras) may be used for surround view, to help identify forward facing paths and obstacles, as well aid in, with the help of one or more controllers 736 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 770 that may be used to perceive objects coming into view from the periphery (e.g., pedestrians, crossing traffic or bicycles). Although only one wide-view camera is illustrated in FIG. 7B, there may be any number (including zero) of wide-view cameras 770 on the vehicle 700. In addition, any number of long-range camera(s) 798 (e.g., a long-view stereo camera pair) may be used for depth-based object detection, especially for objects for which a neural network has not yet been trained. The long-range camera(s) 798 may also be used for object detection and classification, as well as basic object tracking.

Any number of stereo cameras 768 may also be included in a front-facing configuration. In at least one embodiment, one or more of stereo camera(s) 768 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 768 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 768 may be used in addition to, or alternatively from, those described herein.

Cameras with a field of view that include portions of the environment to the side of the vehicle 700 (e.g., side-view cameras) may be used for surround view, providing information used to create and update the occupancy grid, as well as to generate side impact collision warnings. For example, surround camera(s) 774 (e.g., four surround cameras 774 as illustrated in FIG. 7B) may be positioned to on the vehicle 700. The surround camera(s) 774 may include wide-view camera(s) 770, fisheye camera(s), 360 degree camera(s), and/or the like. Four example, four fisheye cameras may be positioned on the vehicle's front, rear, and sides. In an alternative arrangement, the vehicle may use three surround camera(s) 774 (e.g., left, right, and rear), and may leverage one or more other camera(s) (e.g., a forward-facing camera) as a fourth surround view camera.

Cameras with a field of view that include portions of the environment to the rear of the vehicle 700 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 798, stereo camera(s) 768), infrared camera(s) 772, etc.), as described herein.

FIG. 7C is a block diagram of an example system architecture for the example autonomous vehicle 700 of FIG. 7A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 700 in FIG. 7C are illustrated as being connected via bus 702. The bus 702 may include a Controller Area Network (CAN) data interface (alternatively referred to herein as a “CAN bus”). A CAN may be a network inside the vehicle 700 used to aid in control of various features and functionality of the vehicle 700, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 702 is described herein as being a CAN bus, this is not intended to be limiting. For example, in addition to, or alternatively from, the CAN bus, FlexRay and/or Ethernet may be used. Additionally, although a single line is used to represent the bus 702, this is not intended to be limiting. For example, there may be any number of busses 702, which may include one or more CAN busses, one or more FlexRay busses, one or more Ethernet busses, and/or one or more other types of busses using a different protocol. In some examples, two or more busses 702 may be used to perform different functions, and/or may be used for redundancy. For example, a first bus 702 may be used for collision avoidance functionality and a second bus 702 may be used for actuation control. In any example, each bus 702 may communicate with any of the components of the vehicle 700, and two or more busses 702 may communicate with the same components. In some examples, each SoC 704, each controller 736, and/or each computer within the vehicle may have access to the same input data (e.g., inputs from sensors of the vehicle 700), and may be connected to a common bus, such the CAN bus.

The vehicle 700 may include one or more controller(s) 736, such as those described herein with respect to FIG. 7A. The controller(s) 736 may be used for a variety of functions. The controller(s) 736 may be coupled to any of the various other components and systems of the vehicle 700, and may be used for control of the vehicle 700, artificial intelligence of the vehicle 700, infotainment for the vehicle 700, and/or the like.

The vehicle 700 may include a system(s) on a chip (SoC) 704. The SoC 704 may include CPU(s) 706, GPU(s) 708, processor(s) 710, cache(s) 712, accelerator(s) 714, data store(s) 716, and/or other components and features not illustrated. The SoC(s) 704 may be used to control the vehicle 700 in a variety of platforms and systems. For example, the SoC(s) 704 may be combined in a system (e.g., the system of the vehicle 700) with an HD map 722 which may obtain map refreshes and/or updates via a network interface 724 from one or more servers (e.g., server(s) 778 of FIG. 7D).

The CPU(s) 706 may include a CPU cluster or CPU complex (alternatively referred to herein as a “CCPLEX”). The CPU(s) 706 may include multiple cores and/or L2 caches. For example, in some embodiments, the CPU(s) 706 may include eight cores in a coherent multi-processor configuration. In some embodiments, the CPU(s) 706 may include four dual-core clusters where each cluster has a dedicated L2 cache (e.g., a 2 MB L2 cache). The CPU(s) 706 (e.g., the CCPLEX) may be configured to support simultaneous cluster operation enabling any combination of the clusters of the CPU(s) 706 to be active at any given time.

The CPU(s) 706 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 706 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 708 may include an integrated GPU (alternatively referred to herein as an “iGPU”). The GPU(s) 708 may be programmable and may be efficient for parallel workloads. The GPU(s) 708, in some examples, may use an enhanced tensor instruction set. The GPU(s) 708 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 708 may include at least eight streaming microprocessors. The GPU(s) 708 may use compute application programming interface(s) (API(s)). In addition, the GPU(s) 708 may use one or more parallel computing platforms and/or programming models (e.g., NVIDIA's CUDA).

The GPU(s) 708 may be power-optimized for best performance in automotive and embedded use cases. For example, the GPU(s) 708 may be fabricated on a Fin field-effect transistor (FinFET). However, this is not intended to be limiting and the GPU(s) 708 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 708 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 708 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 708 to access the CPU(s) 706 page tables directly. In such examples, when the GPU(s) 708 memory management unit (MMU) experiences a miss, an address translation request may be transmitted to the CPU(s) 706. In response, the CPU(s) 706 may look in its page tables for the virtual-to-physical mapping for the address and transmits the translation back to the GPU(s) 708. As such, unified memory technology may allow a single unified virtual address space for memory of both the CPU(s) 706 and the GPU(s) 708, thereby simplifying the GPU(s) 708 programming and porting of applications to the GPU(s) 708.

In addition, the GPU(s) 708 may include an access counter that may keep track of the frequency of access of the GPU(s) 708 to memory of other processors. The access counter may help ensure that memory pages are moved to the physical memory of the processor that is accessing the pages most frequently.

The SoC(s) 704 may include any number of cache(s) 712, including those described herein. For example, the cache(s) 712 may include an L3 cache that is available to both the CPU(s) 706 and the GPU(s) 708 (e.g., that is connected both the CPU(s) 706 and the GPU(s) 708). The cache(s) 712 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 704 may include an arithmetic logic unit(s) (ALU(s)) which may be leveraged in performing processing with respect to any of the variety of tasks or operations of the vehicle 700—such as processing DNNs. In addition, the SoC(s) 704 may include a floating point unit(s) (FPU(s))—or other math coprocessor or numeric coprocessor types—for performing mathematical operations within the system. For example, the SoC(s) 704 may include one or more FPUs integrated as execution units within a CPU(s) 706 and/or GPU(s) 708.

The SoC(s) 704 may include one or more accelerators 714 (e.g., hardware accelerators, software accelerators, or a combination thereof). For example, the SoC(s) 704 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 708 and to off-load some of the tasks of the GPU(s) 708 (e.g., to free up more cycles of the GPU(s) 708 for performing other tasks). As an example, the accelerator(s) 714 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 714 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 708, and by using an inference accelerator, for example, a designer may target either the DLA(s) or the GPU(s) 708 for any function. For example, the designer may focus processing of CNNs and floating point operations on the DLA(s) and leave other functions to the GPU(s) 708 and/or other accelerator(s) 714.

The accelerator(s) 714 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 706. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 714 (e.g., the hardware acceleration cluster) may include a computer vision network on-chip and SRAM, for providing a high-bandwidth, low latency SRAM for the accelerator(s) 714. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 704 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 714 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 766 output that correlates with the vehicle 700 orientation, distance, 3D location estimates of the object obtained from the neural network and/or other sensors (e.g., LIDAR sensor(s) 764 or RADAR sensor(s) 760), among others.

The SoC(s) 704 may include data store(s) 716 (e.g., memory). The data store(s) 716 may be on-chip memory of the SoC(s) 704, which may store neural networks to be executed on the GPU and/or the DLA. In some examples, the data store(s) 716 may be large enough in capacity to store multiple instances of neural networks for redundancy and safety. The data store(s) 712 may comprise L2 or L3 cache(s) 712. Reference to the data store(s) 716 may include reference to the memory associated with the PVA, DLA, and/or other accelerator(s) 714, as described herein.

The SoC(s) 704 may include one or more processor(s) 710 (e.g., embedded processors). The processor(s) 710 may include a boot and power management processor that may be a dedicated processor and subsystem to handle boot power and management functions and related security enforcement. The boot and power management processor may be a part of the SoC(s) 704 boot sequence and may provide runtime power management services. The boot power and management processor may provide clock and voltage programming, assistance in system low power state transitions, management of SoC(s) 704 thermals and temperature sensors, and/or management of the SoC(s) 704 power states. Each temperature sensor may be implemented as a ring-oscillator whose output frequency is proportional to temperature, and the SoC(s) 704 may use the ring-oscillators to detect temperatures of the CPU(s) 706, GPU(s) 708, and/or accelerator(s) 714. If temperatures are determined to exceed a threshold, the boot and power management processor may enter a temperature fault routine and put the SoC(s) 704 into a lower power state and/or put the vehicle 700 into a chauffeur to safe stop mode (e.g., bring the vehicle 700 to a safe stop).

The processor(s) 710 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 710 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 710 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 710 may further include a real-time camera engine that may include a dedicated processor subsystem for handling real-time camera management.

The processor(s) 710 may further include a high-dynamic range signal processor that may include an image signal processor that is a hardware engine that is part of the camera processing pipeline.

The processor(s) 710 may include a video image compositor that may be a processing block (e.g., implemented on a microprocessor) that implements video post-processing functions needed by a video playback application to produce the final image for the player window. The video image compositor may perform lens distortion correction on wide-view camera(s) 770, surround camera(s) 774, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 708 is not required to continuously render new surfaces. Even when the GPU(s) 708 is powered on and active doing 3D rendering, the video image compositor may be used to offload the GPU(s) 708 to improve performance and responsiveness.

The SoC(s) 704 may further include a mobile industry processor interface (MIPI) camera serial interface for receiving video and input from cameras, a high-speed interface, and/or a video input block that may be used for camera and related pixel input functions. The SoC(s) 704 may further include an input/output controller(s) that may be controlled by software and may be used for receiving I/O signals that are uncommitted to a specific role.

The SoC(s) 704 may further include a broad range of peripheral interfaces to enable communication with peripherals, audio codecs, power management, and/or other devices. The SoC(s) 704 may be used to process data from cameras (e.g., connected over Gigabit Multimedia Serial Link and Ethernet), sensors (e.g., LIDAR sensor(s) 764, RADAR sensor(s) 760, etc. that may be connected over Ethernet), data from bus 702 (e.g., speed of vehicle 700, steering wheel position, etc.), data from GNSS sensor(s) 758 (e.g., connected over Ethernet or CAN bus). The SoC(s) 704 may further include dedicated high-performance mass storage controllers that may include their own DMA engines, and that may be used to free the CPU(s) 706 from routine data management tasks.

The SoC(s) 704 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 704 may be faster, more reliable, and even more energy-efficient and space-efficient than conventional systems. For example, the accelerator(s) 714, when combined with the CPU(s) 706, the GPU(s) 708, and the data store(s) 716, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 720) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 708.

In some examples, a CNN for facial recognition and vehicle owner identification may use data from camera sensors to identify the presence of an authorized driver and/or owner of the vehicle 700. The always on sensor processing engine may be used to unlock the vehicle when the owner approaches the driver door and turn on the lights, and, in security mode, to disable the vehicle when the owner leaves the vehicle. In this way, the SoC(s) 704 provide for security against theft and/or carjacking.

In another example, a CNN for emergency vehicle detection and identification may use data from microphones 796 to detect and identify emergency vehicle sirens. In contrast to conventional systems, that use general classifiers to detect sirens and manually extract features, the SoC(s) 704 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 758. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 762, until the emergency vehicle(s) passes.

The vehicle may include a CPU(s) 718 (e.g., discrete CPU(s), or dCPU(s)), that may be coupled to the SoC(s) 704 via a high-speed interconnect (e.g., PCIe). The CPU(s) 718 may include an X86 processor, for example. The CPU(s) 718 may be used to perform any of a variety of functions, including arbitrating potentially inconsistent results between ADAS sensors and the SoC(s) 704, and/or monitoring the status and health of the controller(s) 736 and/or infotainment SoC 730, for example.

The vehicle 700 may include a GPU(s) 720 (e.g., discrete GPU(s), or dGPU(s)), that may be coupled to the SoC(s) 704 via a high-speed interconnect (e.g., NVIDIA's NVLINK). The GPU(s) 720 may provide additional artificial intelligence functionality, such as by executing redundant and/or different neural networks, and may be used to train and/or update neural networks based on input (e.g., sensor data) from sensors of the vehicle 700.

The vehicle 700 may further include the network interface 724 which may include one or more wireless antennas 726 (e.g., one or more wireless antennas for different communication protocols, such as a cellular antenna, a Bluetooth antenna, etc.). The network interface 724 may be used to enable wireless connectivity over the Internet with the cloud (e.g., with the server(s) 778 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 700 information about vehicles in proximity to the vehicle 700 (e.g., vehicles in front of, on the side of, and/or behind the vehicle 700). This functionality may be part of a cooperative adaptive cruise control functionality of the vehicle 700.

The network interface 724 may include a SoC that provides modulation and demodulation functionality and enables the controller(s) 736 to communicate over wireless networks. The network interface 724 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 700 may further include data store(s) 728 which may include off-chip (e.g., off the SoC(s) 704) storage. The data store(s) 728 may include one or more storage elements including RAM, SRAM, DRAM, VRAM, Flash, hard disks, and/or other components and/or devices that may store at least one bit of data.

The vehicle 700 may further include GNSS sensor(s) 758. The GNSS sensor(s) 758 (e.g., GPS, assisted GPS sensors, differential GPS (DGPS) sensors, etc.), to assist in mapping, perception, occupancy grid generation, and/or path planning functions. Any number of GNSS sensor(s) 758 may be used, including, for example and without limitation, a GPS using a USB connector with an Ethernet to Serial (RS-232) bridge.

The vehicle 700 may further include RADAR sensor(s) 760. The RADAR sensor(s) 760 may be used by the vehicle 700 for long-range vehicle detection, even in darkness and/or severe weather conditions. RADAR functional safety levels may be ASIL B. The RADAR sensor(s) 760 may use the CAN and/or the bus 702 (e.g., to transmit data generated by the RADAR sensor(s) 760) for control and to access object tracking data, with access to Ethernet to access raw data in some examples. A wide variety of RADAR sensor types may be used. For example, and without limitation, the RADAR sensor(s) 760 may be suitable for front, rear, and side RADAR use. In some example, Pulse Doppler RADAR sensor(s) are used.

The RADAR sensor(s) 760 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 760 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 700 surroundings at higher speeds with minimal interference from traffic in adjacent lanes. The other two antennae may expand the field of view, making it possible to quickly detect vehicles entering or leaving the vehicle's 700 lane.

Mid-range RADAR systems may include, as an example, a range of up to 760 m (front) or 80 m (rear), and a field of view of up to 42 degrees (front) or 750 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 700 may further include ultrasonic sensor(s) 762. The ultrasonic sensor(s) 762, which may be positioned at the front, back, and/or the sides of the vehicle 700, may be used for park assist and/or to create and update an occupancy grid. A wide variety of ultrasonic sensor(s) 762 may be used, and different ultrasonic sensor(s) 762 may be used for different ranges of detection (e.g., 2.5 m, 4 m). The ultrasonic sensor(s) 762 may operate at functional safety levels of ASIL B.

The vehicle 700 may include LIDAR sensor(s) 764. The LIDAR sensor(s) 764 may be used for object and pedestrian detection, emergency braking, collision avoidance, and/or other functions. The LIDAR sensor(s) 764 may be functional safety level ASIL B. In some examples, the vehicle 700 may include multiple LIDAR sensors 764 (e.g., two, four, six, etc.) that may use Ethernet (e.g., to provide data to a Gigabit Ethernet switch).

In some examples, the LIDAR sensor(s) 764 may be capable of providing a list of objects and their distances for a 360-degree field of view. Commercially available LIDAR sensor(s) 764 may have an advertised range of approximately 700 m, with an accuracy of 2 cm-3 cm, and with support for a 700 Mbps Ethernet connection, for example. In some examples, one or more non-protruding LIDAR sensors 764 may be used. In such examples, the LIDAR sensor(s) 764 may be implemented as a small device that may be embedded into the front, rear, sides, and/or corners of the vehicle 700. The LIDAR sensor(s) 764, in such examples, may provide up to a 120-degree horizontal and 35-degree vertical field-of-view, with a 200 m range even for low-reflectivity objects. Front-mounted LIDAR sensor(s) 764 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 700. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 764 may be less susceptible to motion blur, vibration, and/or shock.

The vehicle may further include IMU sensor(s) 766. The IMU sensor(s) 766 may be located at a center of the rear axle of the vehicle 700, in some examples. The IMU sensor(s) 766 may include, for example and without limitation, an accelerometer(s), a magnetometer(s), a gyroscope(s), a magnetic compass(es), and/or other sensor types. In some examples, such as in six-axis applications, the IMU sensor(s) 766 may include accelerometers and gyroscopes, while in nine-axis applications, the IMU sensor(s) 766 may include accelerometers, gyroscopes, and magnetometers.

In some embodiments, the IMU sensor(s) 766 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 766 may enable the vehicle 700 to estimate heading without requiring input from a magnetic sensor by directly observing and correlating the changes in velocity from GPS to the IMU sensor(s) 766. In some examples, the IMU sensor(s) 766 and the GNSS sensor(s) 758 may be combined in a single integrated unit.

The vehicle may include microphone(s) 796 placed in and/or around the vehicle 700. The microphone(s) 796 may be used for emergency vehicle detection and identification, among other things.

The vehicle may further include any number of camera types, including stereo camera(s) 768, wide-view camera(s) 770, infrared camera(s) 772, surround camera(s) 774, long-range and/or mid-range camera(s) 798, and/or other camera types. The cameras may be used to capture image data around an entire periphery of the vehicle 700. The types of cameras used depends on the embodiments and requirements for the vehicle 700, and any combination of camera types may be used to provide the necessary coverage around the vehicle 700. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 7A and FIG. 7B.

The vehicle 700 may further include vibration sensor(s) 742. The vibration sensor(s) 742 may measure vibrations of components of the vehicle, such as the axle(s). For example, changes in vibrations may indicate a change in road surfaces. In another example, when two or more vibration sensors 742 are used, the differences between the vibrations may be used to determine friction or slippage of the road surface (e.g., when the difference in vibration is between a power-driven axle and a freely rotating axle).

The vehicle 700 may include an ADAS system 738. The ADAS system 738 may include a SoC, in some examples. The ADAS system 738 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 760, LIDAR sensor(s) 764, and/or a camera(s). The ACC systems may include longitudinal ACC and/or lateral ACC. Longitudinal ACC monitors and controls the distance to the vehicle immediately ahead of the vehicle 700 and automatically adjust the vehicle speed to maintain a safe distance from vehicles ahead. Lateral ACC performs distance keeping, and advises the vehicle 700 to change lanes when necessary. Lateral ACC is related to other ADAS applications such as LCA and CWS.

CACC uses information from other vehicles that may be received via the network interface 724 and/or the wireless antenna(s) 726 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 700), while the 12V communication concept provides information about traffic further ahead. CACC systems may include either or both 12V and V2V information sources. Given the information of the vehicles ahead of the vehicle 700, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 760, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 760, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 700 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 700 if the vehicle 700 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 760, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 700 is backing up. Some RCTW systems include AEB to ensure that the vehicle brakes are applied to avoid a crash. RCTW systems may use one or more rear-facing RADAR sensor(s) 760, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 700, the vehicle 700 itself must, in the case of conflicting results, decide whether to heed the result from a primary computer or a secondary computer (e.g., a first controller 736 or a second controller 736). For example, in some embodiments, the ADAS system 738 may be a backup and/or secondary computer for providing perception information to a backup computer rationality module. The backup computer rationality monitor may run a redundant diverse software on hardware components to detect faults in perception and dynamic driving tasks. Outputs from the ADAS system 738 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 704.

In other examples, ADAS system 738 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 738 may be fed into the primary computer's perception block and/or the primary computer's dynamic driving task block. For example, if the ADAS system 738 indicates a forward crash warning due to an object immediately ahead, the perception block may use this information when identifying objects. In other examples, the secondary computer may have its own neural network which is trained and thus reduces the risk of false positives, as described herein.

The vehicle 700 may further include the infotainment SoC 730 (e.g., an in-vehicle infotainment system (IVI)). Although illustrated and described as a SoC, the infotainment system may not be a SoC, and may include two or more discrete components. The infotainment SoC 730 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 700. For example, the infotainment SoC 730 may radios, disk players, navigation systems, video players, USB and Bluetooth connectivity, carputers, in-car entertainment, Wi-Fi, steering wheel audio controls, hands free voice control, a heads-up display (HUD), an HMI display 734, a telematics device, a control panel (e.g., for controlling and/or interacting with various components, features, and/or systems), and/or other components. The infotainment SoC 730 may further be used to provide information (e.g., visual and/or audible) to a user(s) of the vehicle, such as information from the ADAS system 738, autonomous driving information such as planned vehicle maneuvers, trajectories, surrounding environment information (e.g., intersection information, vehicle information, road information, etc.), and/or other information.

The infotainment SoC 730 may include GPU functionality. The infotainment SoC 730 may communicate over the bus 702 (e.g., CAN bus, Ethernet, etc.) with other devices, systems, and/or components of the vehicle 700. In some examples, the infotainment SoC 730 may be coupled to a supervisory MCU such that the GPU of the infotainment system may perform some self-driving functions in the event that the primary controller(s) 736 (e.g., the primary and/or backup computers of the vehicle 700) fail. In such an example, the infotainment SoC 730 may put the vehicle 700 into a chauffeur to safe stop mode, as described herein.

The vehicle 700 may further include an instrument cluster 732 (e.g., a digital dash, an electronic instrument cluster, a digital instrument panel, etc.). The instrument cluster 732 may include a controller and/or supercomputer (e.g., a discrete controller or supercomputer). The instrument cluster 732 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 730 and the instrument cluster 732. In other words, the instrument cluster 732 may be included as part of the infotainment SoC 730, or vice versa.

FIG. 7D is a system diagram for communication between cloud-based server(s) and the example autonomous vehicle 700 of FIG. 7A, in accordance with some embodiments of the present disclosure. The system 776 may include server(s) 778, network(s) 790, and vehicles, including the vehicle 700. The server(s) 778 may include a plurality of GPUs 784(A)-784(H) (collectively referred to herein as GPUs 784), PCIe switches 782(A)-782(H) (collectively referred to herein as PCIe switches 782), and/or CPUs 780(A)-780(B) (collectively referred to herein as CPUs 780). The GPUs 784, the CPUs 780, and the PCIe switches may be interconnected with high-speed interconnects such as, for example and without limitation, NVLink interfaces 788 developed by NVIDIA and/or PCIe connections 786. In some examples, the GPUs 784 are connected via NVLink and/or NVSwitch SoC and the GPUs 784 and the PCIe switches 782 are connected via PCIe interconnects. Although eight GPUs 784, two CPUs 780, and two PCIe switches are illustrated, this is not intended to be limiting. Depending on the embodiment, each of the server(s) 778 may include any number of GPUs 784, CPUs 780, and/or PCIe switches. For example, the server(s) 778 may each include eight, sixteen, thirty-two, and/or more GPUs 784.

The server(s) 778 may receive, over the network(s) 790 and from the vehicles, image data representative of images showing unexpected or changed road conditions, such as recently commenced road-work. The server(s) 778 may transmit, over the network(s) 790 and to the vehicles, neural networks 792, updated neural networks 792, and/or map information 794, including information regarding traffic and road conditions. The updates to the map information 794 may include updates for the HD map 722, such as information regarding construction sites, potholes, detours, flooding, and/or other obstructions. In some examples, the neural networks 792, the updated neural networks 792, and/or the map information 794 may have resulted from new training and/or experiences represented in data received from any number of vehicles in the environment, and/or based on training performed at a datacenter (e.g., using the server(s) 778 and/or other servers).

The server(s) 778 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 790, and/or the machine learning models may be used by the server(s) 778 to remotely monitor the vehicles.

In some examples, the server(s) 778 may receive data from the vehicles and apply the data to up-to-date real-time neural networks for real-time intelligent inferencing. The server(s) 778 may include deep-learning supercomputers and/or dedicated AI computers powered by GPU(s) 784, such as a DGX and DGX Station machines developed by NVIDIA. However, in some examples, the server(s) 778 may include deep learning infrastructure that use only CPU-powered datacenters.

The deep-learning infrastructure of the server(s) 778 may be capable of fast, real-time inferencing, and may use that capability to evaluate and verify the health of the processors, software, and/or associated hardware in the vehicle 700. For example, the deep-learning infrastructure may receive periodic updates from the vehicle 700, such as a sequence of images and/or objects that the vehicle 700 has located in that sequence of images (e.g., via computer vision and/or other machine learning object classification techniques). The deep-learning infrastructure may run its own neural network to identify the objects and compare them with the objects identified by the vehicle 700 and, if the results do not match and the infrastructure concludes that the AI in the vehicle 700 is malfunctioning, the server(s) 778 may transmit a signal to the vehicle 700 instructing a fail-safe computer of the vehicle 700 to assume control, notify the passengers, and complete a safe parking maneuver.

For inferencing, the server(s) 778 may include the GPU(s) 784 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 8 is a block diagram of an example computing device(s) 800 suitable for use in implementing some embodiments of the present disclosure. Computing device 800 may include an interconnect system 802 that directly or indirectly couples the following devices: memory 804, one or more central processing units (CPUs) 806, one or more graphics processing units (GPUs) 808, a communication interface 810, input/output (I/O) ports 812, input/output components 814, a power supply 816, one or more presentation components 818 (e.g., display(s)), and one or more logic units 820. In at least one embodiment, the computing device(s) 800 may comprise one or more virtual machines (VMs), and/or any of the components thereof may comprise virtual components (e.g., virtual hardware components). For non-limiting examples, one or more of the GPUs 808 may comprise one or more vGPUs, one or more of the CPUs 806 may comprise one or more vCPUs, and/or one or more of the logic units 820 may comprise one or more virtual logic units. As such, a computing device(s) 800 may include discrete components (e.g., a full GPU dedicated to the computing device 800), virtual components (e.g., a portion of a GPU dedicated to the computing device 800), or a combination thereof.

Although the various blocks of FIG. 8 are shown as connected via the interconnect system 802 with lines, this is not intended to be limiting and is for clarity only. For example, in some embodiments, a presentation component 818, such as a display device, may be considered an I/O component 814 (e.g., if the display is a touch screen). As another example, the CPUs 806 and/or GPUs 808 may include memory (e.g., the memory 804 may be representative of a storage device in addition to the memory of the GPUs 808, the CPUs 806, and/or other components). In other words, the computing device of FIG. 8 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 8.

The interconnect system 802 may represent one or more links or busses, such as an address bus, a data bus, a control bus, or a combination thereof. The interconnect system 802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 806 may be directly connected to the memory 804. Further, the CPU 806 may be directly connected to the GPU 808. Where there is direct, or point-to-point connection between components, the interconnect system 802 may include a PCIe link to carry out the connection. In these examples, a PCI bus need not be included in the computing device 800.

The memory 804 may include any of a variety of computer-readable media. The computer-readable media may be any available media that may be accessed by the computing device 800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 800. As used herein, computer storage media does not comprise signals per sc.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 806 may be configured to execute at least some of the computer-readable instructions to control one or more components of the computing device 800 to perform one or more of the methods and/or processes described herein. The CPU(s) 806 may each include one or more cores (e.g., one, two, four, eight, twenty-eight, seventy-two, etc.) that are capable of handling a multitude of software threads simultaneously. The CPU(s) 806 may include any type of processor, and may include different types of processors depending on the type of computing device 800 implemented (e.g., processors with fewer cores for mobile devices and processors with more cores for servers). For example, depending on the type of computing device 800, the processor may be an Advanced RISC Machines (ARM) processor implemented using Reduced Instruction Set Computing (RISC) or an x86 processor implemented using Complex Instruction Set Computing (CISC). The computing device 800 may include one or more CPUs 806 in addition to one or more microprocessors or supplementary co-processors, such as math co-processors.

In addition to or alternatively from the CPU(s) 806, the GPU(s) 808 may be configured to execute at least some of the computer-readable instructions to control one or more components of the computing device 800 to perform one or more of the methods and/or processes described herein. One or more of the GPU(s) 808 may be an integrated GPU (e.g., with one or more of the CPU(s) 806 and/or one or more of the GPU(s) 808 may be a discrete GPU. In embodiments, one or more of the GPU(s) 808 may be a coprocessor of one or more of the CPU(s) 806. The GPU(s) 808 may be used by the computing device 800 to render graphics (e.g., 3D graphics) or perform general purpose computations. For example, the GPU(s) 808 may be used for General-Purpose computing on GPUs (GPGPU). The GPU(s) 808 may include hundreds or thousands of cores that are capable of handling hundreds or thousands of software threads simultaneously. The GPU(s) 808 may generate pixel data for output images in response to rendering commands (e.g., rendering commands from the CPU(s) 806 received via a host interface). The GPU(s) 808 may include graphics memory, such as display memory, for storing pixel data or any other suitable data, such as GPGPU data. The display memory may be included as part of the memory 804. The GPU(s) 808 may include two or more GPUs operating in parallel (e.g., via a link). The link may directly connect the GPUs (e.g., using NVLINK) or may connect the GPUs through a switch (e.g., using NVSwitch). When combined together, each GPU 808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 806 and/or the GPU(s) 808, the logic unit(s) 820 may be configured to execute at least some of the computer-readable instructions to control one or more components of the computing device 800 to perform one or more of the methods and/or processes described herein. In embodiments, the CPU(s) 806, the GPU(s) 808, and/or the logic unit(s) 820 may discretely or jointly perform any combination of the methods, processes and/or portions thereof. One or more of the logic units 820 may be part of and/or integrated in one or more of the CPU(s) 806 and/or the GPU(s) 808 and/or one or more of the logic units 820 may be discrete components or otherwise external to the CPU(s) 806 and/or the GPU(s) 808. In embodiments, one or more of the logic units 820 may be a coprocessor of one or more of the CPU(s) 806 and/or one or more of the GPU(s) 808.

Examples of the logic unit(s) 820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Trec Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 810 may include one or more receivers, transmitters, and/or transceivers that enable the computing device 800 to communicate with other computing devices via an electronic communication network, included wired and/or wireless communications. The communication interface 810 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 820 and/or communication interface 810 may include one or more data processing units (DPUs) to transmit data received over a network and/or through interconnect system 802 directly to (e.g., a memory of) one or more GPU(s) 808.

The I/O ports 812 may enable the computing device 800 to be logically coupled to other devices including the I/O components 814, the presentation component(s) 818, and/or other components, some of which may be built in to (e.g., integrated in) the computing device 800. Illustrative I/O components 814 include a microphone, mouse, keyboard, joystick, game pad, game controller, satellite dish, scanner, printer, wireless device, etc. The I/O components 814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 800. The computing device 800 may be include depth cameras, such as stereoscopic camera systems, infrared camera systems, RGB camera systems, touchscreen technology, and combinations of these, for gesture detection and recognition. Additionally, the computing device 800 may include accelerometers or gyroscopes (e.g., as part of an inertia measurement unit (IMU)) that enable detection of motion. In some examples, the output of the accelerometers or gyroscopes may be used by the computing device 800 to render immersive augmented reality or virtual reality.

The power supply 816 may include a hard-wired power supply, a battery power supply, or a combination thereof. The power supply 816 may provide power to the computing device 800 to enable the components of the computing device 800 to operate.

The presentation component(s) 818 may include a display (e.g., a monitor, a touch screen, a television screen, a heads-up-display (HUD), other display types, or a combination thereof), speakers, and/or other presentation components. The presentation component(s) 818 may receive data from other components (e.g., the GPU(s) 808, the CPU(s) 806, DPUs, etc.), and output the data (e.g., as an image, video, sound, etc.).

### Example Data Center

FIG. 9 illustrates an example data center 900 that may be used in at least one embodiments of the present disclosure. The data center 900 may include a data center infrastructure layer 910, a framework layer 920, a software layer 930, and/or an application layer 940.

As shown in FIG. 9, the data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 916(1)-916 (N) may correspond to a server having one or more of the above-mentioned computing resources. In addition, in some embodiments, the node C.R.s 916(1)-9161(N) may include one or more virtual components, such as vGPUs, vCPUs, and/or the like, and/or one or more of the node C.R.s 916(1)-916(N) may correspond to a virtual machine (VM).

In at least one embodiment, grouped computing resources 914 may include separate groupings of node C.R.s 916 housed within one or more racks (not shown), or many racks housed in data centers at various geographical locations (also not shown). Separate groupings of node C.R.s 916 within grouped computing resources 914 may include grouped compute, network, memory or storage resources that may be configured or allocated to support one or more workloads. In at least one embodiment, several node C.R.s 916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 912 may configure or otherwise control one or more node C.R.s 916(1)-916(N) and/or grouped computing resources 914. In at least one embodiment, resource orchestrator 912 may include a software design infrastructure (SDI) management entity for the data center 900. The resource orchestrator 912 may include hardware, software, or some combination thereof.

In at least one embodiment, as shown in FIG. 9, framework layer 920 may include a job scheduler 933, a configuration manager 934, a resource manager 936, and/or a distributed file system 938. The framework layer 920 may include a framework to support software 932 of software layer 930 and/or one or more application(s) 942 of application layer 940. The software 932 or application(s) 942 may respectively include web-based service software or applications, such as those provided by Amazon Web Services, Google Cloud and Microsoft Azure. The framework layer 920 may be, but is not limited to, a type of free and open-source software web application framework such as Apache Spark™ (hereinafter “Spark”) that may use distributed file system 938 for large-scale data processing (e.g., “big data”). In at least one embodiment, job scheduler 933 may include a Spark driver to facilitate scheduling of workloads supported by various layers of data center 900. The configuration manager 934 may be capable of configuring different layers such as software layer 930 and framework layer 920 including Spark and distributed file system 938 for supporting large-scale data processing. The resource manager 936 may be capable of managing clustered or grouped computing resources mapped to or allocated for support of distributed file system 938 and job scheduler 933. In at least one embodiment, clustered or grouped computing resources may include grouped computing resource 914 at data center infrastructure layer 910. The resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. One or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916 (N), grouped computing resources 914, and/or distributed file system 938 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. Self-modifying actions may relieve a data center operator of data center 900 from making possibly bad configuration decisions and possibly avoiding underused and/or poor performing portions of a data center.

The data center 900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 900. In at least one embodiment, trained or deployed machine learning models corresponding to one or more neural networks may be used to infer or predict information using resources described above with respect to the data center 900 by using weight parameters calculated through one or more training techniques, such as but not limited to those described herein.

In at least one embodiment, the data center 900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 800 of FIG. 8—e.g., each device may include similar components, features, and/or functionality of the computing device(s) 800. In addition, where backend devices (e.g., servers, NAS, etc.) are implemented, the backend devices may be included as part of a data center 900, an example of which is described in more detail herein with respect to FIG. 9.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 800 described herein with respect to FIG. 8. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A system comprising: one or more processors to: determine, based at least on wireless networking data obtained using one or more machines in an environment, one or more network performance scores associated with one or more network access devices located within the environment; determine, based at least on the one or more network performance scores, a network access device of the one or more network access devices to use for network connectivity at a location in the environment; and generate map data associated with the environment, the map data indicating to use the network access device for the network connectivity at the location.

B. The system of paragraph A, wherein the determination of the network access device to use for the network connectivity at the location is based at least on a network performance score associated with the network access device being greater, at the location, than a second network performance score associated with a second network access device.

C. The system of any one of paragraphs A-B, wherein the one or more processors are further to: determine, based at least on the one or more network performance scores, a second network access device of the one or more network access devices to use for the network connectivity at a second location within the environment; and generate the map data to further indicate to use the second network access device for the network connectivity at the second location.

D. The system of any one of paragraphs A-C, wherein: the one or more network performance scores are indicative of at least a first signal strength associated with the network access device and a second signal strength associated with a second network access device of the one or more network access devices; and the determination of the network access device to use for network connectivity at the location is based at least on the first signal strength being greater, at the location, than the second signal strength.

E. The system of any one of paragraphs A-D, wherein: the one or more network performance scores are indicative of at least a first network characteristic value associated with the network access device and a second network characteristic value associated with a second network access device of the one or more network access devices; and the determining the network access device to use for network connectivity at the location is based at least on the first network characteristic value indicating a better network connection at the location as compared to the second network characteristic value.

F. The system of any one of paragraphs A-E, wherein the one or more processors are further to: determine, based at least on the one or more network performance scores, a second network access device to use as a backup to the network access device for the network connectivity at the location; and generate the map data to further indicate to use the second network access device as the backup at the location.

G. The system of any one of paragraphs A-F, wherein the one or more processors are further to: determine, based at least on the one or more network performance scores, to use the network access device as a backup to a second network access device for the network connectivity at a second location; and generate the map data to further indicate to use the network access device as the backup at the second location.

H. The system of any one of paragraphs A-G, wherein the one or more processors are further to send the map data to one or more second machines, the map data to cause the one or more second machines to use the network access device when located at the location within the environment.

I. The system of any one of paragraphs A-H, wherein the one or more processors are further to obtain, using the one or more machines in the environment, the wireless network data, the wireless network data comprising one or more of: the one or more network performance scores; or one or more wireless network signals received using the one or more machines and from the one or more network access devices.

J. The system of any one of paragraphs A-I, wherein the one or more network performance scores are indicative of one or more locations in the environment where a signal strength associated with the network access device is maximized.

K. The system of any one of paragraphs A-J, wherein the map data comprises a base map portion representing the environment and a network portion including one or more bounding areas corresponding to one or more locations in the environment, the one or more bounding areas including a bounding area corresponding to the location in the environment, the bounding area indicating to use the network access device for the network connectivity within the bounding area.

L. The system of any one of paragraphs A-K, wherein the one or more processors are further to: provide the map data to one or more second machines; obtain, using the one or more second machines, second wireless networking data; and update, based at least on the second wireless networking data, the map data to indicate to use a second network access device for the network connectivity at the location.

M. The system of any one of paragraphs A-L, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

N. A method comprising: obtaining map data representing an environment, the map data indicating one or more network access devices to use for network connectivity at one or more locations in the environment; determining, based at least on sensor data, a location of a machine relative to the environment represented in the map data; and causing the machine to establish a network connection with a network access device of the one or more network access devices based at least on the map data associating the network access device with the location.

O. The method of paragraph N, further comprising: determining, based at least on second sensor data, a second location of the machine relative to the environment represented in the map data; and causing the machine to establish a second network connection with a second network access device of the one or more network access devices based at least on the map data associating the second network access device with the second location.

P. The method of any one of paragraphs N-O, wherein: the map data further indicates a second network access device of the one or more network access devices to use as a backup to the network access device at the location; and the method further comprises causing the machine to establish a second network connection with the second network access device based at least on a determination that a network performance score associated with the network access device is below a threshold.

Q. The method of any one of paragraphs N-P, further comprising: causing the machine to establish a second network connection with a second network access device based at least on a determination that a network performance score associated with the network access device is below a threshold; and causing an update to the map data to associate the second network access device with the location.

R. The method of any one of paragraphs N-Q, wherein the map data comprises a base map portion representing the environment and a network portion indicating the one or more network access devices to use for the network connectivity at the one or more locations, the network portion including one or more bounding areas corresponding to the one or more locations, the one or more bounding areas including a bounding area corresponding to the location in the environment, the bounding area indicating to use the network access device for the network connectivity while the machine is located within the bounding area.

S. One or more processors comprising: processing circuitry to cause a machine to switch a network connection from a first network access device to a second network access device based at least on a location of the machine within an environment and map data representing the environment, the map data associating the second network access device with the location of the machine within the environment.

T. The one or more processors of paragraph S, wherein the one or more processors is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A system comprising:
one or more processors to:
determine, based at least on wireless networking data obtained using one or more machines in an environment, one or more network performance scores associated with one or more network access devices located within the environment;
determine, based at least on the one or more network performance scores, a network access device of the one or more network access devices to use for network connectivity at a location in the environment; and
generate map data associated with the environment, the map data indicating to use the network access device for the network connectivity at the location.

2. The system of claim 1, wherein the determination of the network access device to use for the network connectivity at the location is based at least on a network performance score associated with the network access device being greater, at the location, than a second network performance score associated with a second network access device.

3. The system of claim 1, wherein the one or more processors are further to:
determine, based at least on the one or more network performance scores, a second network access device of the one or more network access devices to use for the network connectivity at a second location within the environment; and
generate the map data to further indicate to use the second network access device for the network connectivity at the second location.

4. The system of claim 1, wherein:
the one or more network performance scores are indicative of at least a first signal strength associated with the network access device and a second signal strength associated with a second network access device of the one or more network access devices; and
the determination of the network access device to use for network connectivity at the location is based at least on the first signal strength being greater, at the location, than the second signal strength.

5. The system of claim 1, wherein:
the one or more network performance scores are indicative of at least a first network characteristic value associated with the network access device and a second network characteristic value associated with a second network access device of the one or more network access devices; and
the determining the network access device to use for network connectivity at the location is based at least on the first network characteristic value indicating a better network connection at the location as compared to the second network characteristic value.

6. The system of claim 1, wherein the one or more processors are further to:
determine, based at least on the one or more network performance scores, a second network access device to use as a backup to the network access device for the network connectivity at the location; and
generate the map data to further indicate to use the second network access device as the backup at the location.

7. The system of claim 1, wherein the one or more processors are further to:
determine, based at least on the one or more network performance scores, to use the network access device as a backup to a second network access device for the network connectivity at a second location; and
generate the map data to further indicate to use the network access device as the backup at the second location.

8. The system of claim 1, wherein the one or more processors are further to send the map data to one or more second machines, the map data to cause the one or more second machines to use the network access device when located at the location within the environment.

9. The system of claim 1, wherein the one or more processors are further to obtain, using the one or more machines in the environment, the wireless network data, the wireless network data comprising one or more of:
the one or more network performance scores; or
one or more wireless network signals received using the one or more machines and from the one or more network access devices.

10. The system of claim 1, wherein the one or more network performance scores are indicative of one or more locations in the environment where a signal strength associated with the network access device is maximized.

11. The system of claim 1, wherein the map data comprises a base map portion representing the environment and a network portion including one or more bounding areas corresponding to one or more locations in the environment, the one or more bounding areas including a bounding area corresponding to the location in the environment, the bounding area indicating to use the network access device for the network connectivity within the bounding area.

12. The system of claim 1, wherein the one or more processors are further to:
provide the map data to one or more second machines;
obtain, using the one or more second machines, second wireless networking data; and
update, based at least on the second wireless networking data, the map data to indicate to use a second network access device for the network connectivity at the location.

13. The system of claim 1, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

14. A method comprising:
obtaining map data representing an environment, the map data indicating one or more network access devices to use for network connectivity at one or more locations in the environment;
determining, based at least on sensor data, a location of a machine relative to the environment represented in the map data; and
causing the machine to establish a network connection with a network access device of the one or more network access devices based at least on the map data associating the network access device with the location.

15. The method of claim 14, further comprising:
determining, based at least on second sensor data, a second location of the machine relative to the environment represented in the map data; and
causing the machine to establish a second network connection with a second network access device of the one or more network access devices based at least on the map data associating the second network access device with the second location.

16. The method of claim 14, wherein:
the map data further indicates a second network access device of the one or more network access devices to use as a backup to the network access device at the location; and
the method further comprises causing the machine to establish a second network connection with the second network access device based at least on a determination that a network performance score associated with the network access device is below a threshold.

17. The method of claim 14, further comprising:
causing the machine to establish a second network connection with a second network access device based at least on a determination that a network performance score associated with the network access device is below a threshold; and
causing an update to the map data to associate the second network access device with the location.

18. The method of claim 14, wherein the map data comprises a base map portion representing the environment and a network portion indicating the one or more network access devices to use for the network connectivity at the one or more locations, the network portion including one or more bounding areas corresponding to the one or more locations, the one or more bounding areas including a bounding area corresponding to the location in the environment, the bounding area indicating to use the network access device for the network connectivity while the machine is located within the bounding area.

19. One or more processors comprising:
processing circuitry to cause a machine to switch a network connection from a first network access device to a second network access device based at least on a location of the machine within an environment and map data representing the environment, the map data associating the second network access device with the location of the machine within the environment.

20. The one or more processors of claim 19, wherein the one or more processors is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
